(19) United States
(12) Patent Application Publication
(10) Pub. No.: US 2026/0078248 A1
(43) Pub. Date: Mar. 19, 2026

(54) SIDE-CHAIN FUNCTIONALIZED POLYSTYRENES AS MEMBRANE MATERIALS FOR ALKALINE WATER ELECTROLYZERS, FUEL CELLS AND FLOW BATTERIES

(71) Applicant: Forschungszentrum Jülich GmbH, Jülich (DE)

(72) Inventors: Linus M. Hager Sc., Lauf an der Pegnitz (DE); Jochen Kerres, Bubenreuth (DE)

(21) Appl. No.: 19/102,406

(22) PCT Filed: Aug. 9, 2023
(86) PCT No.: PCT/EP2023/072082

§ 371 Date: Feb. 9, 2025

(30) Foreign Application Priority Data
Aug. 10, 2022 (DE) 10 2022 120 196.1

(51) Int. Cl. C08L 25/18; B01J 41/04; B01J 41/14; B01J 47/12; C08F 8/32; C08L 79/08; C25B 13/08; H01M 8/10; H01M 8/1023; H01M 8/1044; H01M 8/18

(52) U.S. Cl. CPC C08L 25/18; B01J 41/04; B01J 41/14; B01J 47/12; C08F 8/32; C08L 79/08; C25B 13/08; H01M 8/1023; H01M 8/1044; H01M 8/188; H01M 2008/1095

(57) ABSTRACT

The present invention relates to side-chain functionalized polymers and copolymers and their use as alkaline anion exchange membrane materials, for example in alkaline water electrolyzers, fuel cells or flow batteries.

### CROSS-REFERENCE TO RELATED APPLICATIONS

This application is the National Stage of International Application No. PCT/EP2023/072082, filed on Aug. 9, 2023, which claims the benefit of DE102022120196.1, filed on Aug. 10, 2022.

### TECHNICAL FIELD

The present invention relates to side-chain functionalized polymers and copolymers and their use as alkaline anion exchange membrane materials, for example in alkaline water electrolyzers, fuel cells or flow batteries.

### BACKGROUND

In alkaline water electrolysis, water is split into hydrogen and oxygen by applying an electrical potential. On the anode side, oxygen is formed by consuming four equivalents of hydroxide and releasing electrons (oxidation). In the cathode chamber, hydrogen is formed by taking up electrons (reduction) and forming two equivalents of hydroxide. The opposite/complementary electrochemical process to water electrolysis is the alkaline membrane fuel cell. The following electrode reactions take place in the alkaline membrane fuel cell:

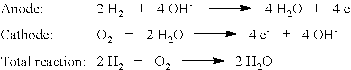

Hydroxide transport from the cathode side to the anode side is therefore necessary to maintain the two half-reactions of electrolysis and fuel cell. Anion-conducting polymer membranes (AEMs) fulfill this purpose and are therefore used as alkaline anion exchange membranes.

In order to be used as an electrolyte in alkaline water electrolysis or in alkaline fuel cells, such AEMs must be stable under the aggressive conditions present, such as alkaline environment, electrical potential and nucleophilicity of the hydroxide. In addition, the materials used must have a high hydroxide conductivity so that high current densities are possible.

Compared to proton-conducting materials used in water electrolysis or in PEM fuel cells with polymer membranes under acidic conditions, AEMs under alkaline conditions are less common and there is no standard material, such as Nafion, for acidic applications. Commercially available are, for example, membranes based on polyaromatics with ether bridges in the polymer backbone (Fumasep® FAA3 from Fumatech) and quaternary ammonium substituents as anion exchange groups (D. Henkensmeier et al., Overview: State-of-the Art Commercial Membranes for Anion Exchange Membrane Water Electrolysis, Journal of Electrochemical Energy Conversion and Storage, 2021, 18. DOL 10.1115/1.4047963; S. Gottesfeld et al, Anion exchange membrane fuel cells: Current status and remaining challenges, Journal of Power Sources, 2018, 375, 170-184).

These membranes can be reinforced or non-reinforced, whereby particularly the ether bond between the aromatic compounds is a weak point under alkaline conditions (D. Henkensmeier et al., 2021; Gottesfeld et al., 2018; N. Chen et al., Anion exchange polyelectrolytes for membranes and ionomers, Progress in Polymer Science, 2021, 113, 101345).

In addition, membranes for alkaline electrolysis based on methylated polybenzimidazole (Aemion™ from Ionomr) are available (D. Henkensmeier et al., 2021; A. G. Wright et al, Hexamethyl-p-terphenyl poly(benzimidazolium): a universal hydroxide-conducting polymer for energy conversion devices, Energy Environ. Sci., 2016, 9, 2130-2142).

Membranes made from poly(4-vinylbenzyl chloride-co-styrene) are also frequently used. Commercially available is the membrane Sustainion® from Dioxide Materials, where the benzylic chloride group in poly(4-vinylbenzyl chloride-co-styrene) has been quaternized with 2,3,4,5-tetramethylimidazole (J. J. Kaczur et al, Carbon Dioxide and Water Electrolysis Using New Alkaline Stable Anion Membranes, Frontiers in chemistry, 2018, 6, 263; R. B. Kutz et al, Sustainion Imidazolium-Functionalized Polymers for Carbon Dioxide Electrolysis, Energy Technol., 2017, 5, 929-936; D. Li et al, Durability of anion exchange membrane water electrolyzers, Energy Environ. Sci, 2021, 14, 3393-3419; Z. Liu et al, The effect of membrane on an alkaline water electrolyzer, International Journal of Hydrogen Energy, 2017, 42, 29661-29665; Z. Liu et al, CO₂ Electrolysis to CO and O₂ at High Selectivity, Stability and Efficiency Using Sustainion Membranes, J. Electrochem. Soc, 2018, 165, J3371-J3377; R. I. Masel et al, Anion Exchange Membrane Electrolyzers Showing 1 A/cm² at Less Than 2 V, ECS Trans., 2016, 75, 1143-1146; S. D. Sajjad et al, Tunable-High Performance Sustainion™ Anion Exchange Membranes for Electrochemical Applications, ECS Trans., 2017, 77, 1653-1656; D. A. Salvatore et al, Designing anion exchange membranes for CO₂ electrolysers, Nat Energy, 2021, 6, 339-348).

Aryl ether bonds in the polymer backbone (e.g. Fumasep® FAA3) are particularly disadvantageous for long-lasting membranes, as these can be directly attacked by hydroxide ions in a nucleophilic substitution. This inevitably leads to a considerable molar mass reduction and thus not only to lower conductivity, but also to a loss of mechanical integrity (A. D. Mohanty et al., Systematic Alkaline Stability Study of Polymer Backbones for Anion Exchange Membrane Applications, Macromolecules, 2016, 49, 3361-3372).

Polybenzimidazoles are generally known to be chemically very stable, whereby the degradation of such membranes can occur through a nucleophilic attack of the hydroxide on the imidazole ring with ring opening (D. Henkensmeier et al, Polybenzimidazolium hydroxides—Structure, stability and degradation, Polymer Degradation and Stability, 2012, 97, 264-272). Technically, attempts are being made to counteract this degradation mechanism by increasing the electron density at the imidazole unit and sterically shielding the imidazole unit (Wright et al., 2016).

Even though better performance in alkaline water electrolysis was achieved with Sustainion® compared to the other materials, the low alkali stability of benzylic ammonium groups and the inherent fragility of polystyrene represent a disadvantage of this membrane (T. H. Pham et al., Aromatic Polymers Incorporating Bis-N-spirocyclic Quaternary Ammonium Moieties for Anion-Exchange Membranes, ACS Macro Lett, 2015, 4, 1370-1375; M. R. Hibbs, Alkaline stability of poly(phenylene)-based anion exchange membranes with various cations, J Polym. Sci. Part B: Polym. Phys., 2013, 51, 1736-1742; Y.-K. Choe et al, Alkaline Stability of Benzyl Trimethyl Ammonium Functionalized Polyaromatics: A Computational and Experimental Study, Chem. Mater., 2014, 26, 5675-5682; Chen et al, 2021).

It is known from the technical literature that the separation of the anion exchange group (usually a quaternary ammonium group) from the polymer backbone increases the conductivity due to the micro/nanophase separation that forms (C. G. Arges et al, Perpendicularly Aligned, Anion Conducting Nanochannels in Block Copolymer Electrolyte Films, Chem. Mater., 2016, 28, 1377-1389; H.-S. Dang et al, Exploring Different Cationic Alkyl Side Chain Designs for Enhanced Alkaline Stability and Hydroxide Ion Conductivity of Anion-Exchange Membranes, Macromolecules, 2015, 48, 5742-5751; H.-S. Dang et al, Anion-exchange membranes with polycationic alkyl side chains attached via spacer units, J Mater. Chem. A, 2016, 4, 17138-17153; Y. A. Elabd and M. A. Hickner, Block Copolymers for Fuel Cells, Macromolecules, 2011, 44, 1-11; L. Liu et al, Tuning the properties of poly(2,6-dimethyl-1,4-phenylene oxide) anion exchange membranes and their performance in H2/O2fuel cells, Energy Environ. Sci, 2018, 11, 435-446; S. Miyanishi et al, Highly conductive mechanically robust high Mw polyfluorene anion exchange membrane for alkaline fuel cell and water electrolysis application, Polym. Chem., 2020, 11, 3812-3820; J Pan, C. Chen, Y. Li, L. Wang, L. Tan, G. Li, X Tang, L. Xiao, J Lu and L. Zhuang, Constructing ionic highway in alkaline polymer electrolytes, Energy Environ. Sci, 2014, 7, 354-360; X. Q. Wang et al, Alkali-stable partially fluorinated poly(arylene ether) anion exchange membranes with a claw-type head for fuel cells, J Mater. Chem. A, 2018, 6, 12455-12465).

Furthermore, polymers with side-chain-separated anion exchange groups show increased alkali stability and better cycle stability in alkaline fuel cells and/or electrolysis. For example, Sustainion (poly(4-vinylbenzyl chloride-co-styrene quaternized with 2,3,4,5-tetramethylimidazole) is a type of membrane with properties that are basically suitable for alkaline electrolysis or alkaline fuel cells. However, this polymer class has the inherent disadvantage of labile benzylic ammonium groups.

Wu et al. describe studies on styrene monomers functionalized with quaternary ammonium groups and their conversion to polymers. Possible applications in anion exchange membranes or for water electrolysis are not described [H. Wu et al, Synthesis and polymerization of tail-type cationic polymerizable surfactants and hydrophobic counter-anion induced association of polyelectrolytes, Colloid Polym. Sci., 2004, 282, 1365-1373].

CN 111313066 A describes a method for producing an electrolyte membrane based on styrene-based polymers or copolymers functionalized with bromoalkylene side chains, starting from polystyrene, which is then functionalized with Friedel Craft acylation. The functionalization takes place in a step downstream of the polymerization.

DE 691 19 268 T2 describes cross-linked anion exchange membranes based on functionalized polystyrenes. Brominated alkane styrenes are polymerized, cross-linked and finally quaternized with a quaternary ammonium salt. The resulting membranes exhibit increased heat resistance. Possible applications in anion exchange membranes or for water electrolysis are not described.

WO 2011/125717 A1 discloses a membrane for use in alkaline fuel cells. Here, side-chain-functionalized styrene monomers with a quaternary ammonium group are copolymerized with another crosslinkable monomer. Blend membranes are not described herein.

DE10 2014 009 170 A1 describes inion exchange membranes for use in electrochemical processes, which are in the form of so-called blend membranes. It describes covalently and/or ionically crosslinked polybenzimidazole (PBI) blend membranes, which are produced from halomethylated and optionally suiphonated and/or phosphonated polymers. By adding a low and/or macromolecular crosslinker, these blend membranes can also be covalently crosslinked. The blend membranes described therein are characterized by the fact that they contain halomethylated polymers, i.e. monomer units functionalized with a Hal-CH₂ group. DE10 2014 009 170 A1 also provides an overview of known (non-commercial) AEMs in Table 1:

TABLE 1
Relevant membranes for use in fuel cells

| Membrane and | Chemical | IEC | Conductivity | Measuring | |
|---|---|---|---|---|---|
| manufacturer | Structure | [meq-g⁻¹] | [mS-cm⁻¹] | conditions | Remark |
| Tokuyama C. | Hydrocarbon | 1.7 | approx. 40 | OH⁻ form, 23° C., | n.a. for chemical, |
| Ltd., Japan A 201 | backbone, quart. | | | 90% rel. | thermal and |
| (development | ammonium | | | humidity | mechanical |
| code: A-006) | | | | | stability |
| C. -C. Yang | PVA-ZrO₂—KOH | — | 267 | OH⁻ form, 20° C., | Poor mechanical |
| (2006a)²² Nano- | | | | 20% rel. | properties, |
| composites | | | | humidity | presumably much |
| | | | | | too high |
| | | | | | hydrophilicity |
| El Moussaoui et | ETFE/PE, | 1.5 | 55 | OH⁻ form, 20° C., | n.a. for |
| al. (2006)²³ | functionalized | | | 1N NaOH | mechanical and |
| Radiation ind. | with | | | | thermal stability |
| Plugs | chlorosulfone/ | | | | |
| | TMPDA and | | | | |
| | grafted with | | | | |
| | styrene/DVB | | | | |
| Varcoe et al | ETFE, | 0.74 | 30 | OH⁻ form, 30° C., | n.a. for |
| (2007b)²⁴ | functionalized | | | fully hydrated, | mechanical and |
| Radiation ind. | with | | | water | thermal stability |
| Plugs | benzyltrimethylammonium | | | | |
| Wu and Xu | Chloro-acetylated | approx. 2.0 | 32 | OH⁻ form, 20° C., | n.a. for chemical |
| (2008)²⁵ Glare | PPE and Br-PPE, | | | 100% rel. | stability |
| membrane | quaternized by | | | humidity | |
| | TMA | | | | |
| Hibbs et al | PPE, | 1.57 | 50 | OH⁻ form, 30° C., | Poor mechanical |
| (2009)²⁶ | functionalized | | | fully hydrated, | properties, |
| Homogeneous | with | | | water | WA* = 122% by |
| membrane | benzyltrimethylammonium | | | | weight |
| Robertson et al | Olefin | 2.3 | 68.710 | OH⁻ form, 22° C. | Poor chemical |
| (2010b)²⁷ | copolymers, | | | Cl⁻ form, | stability in |
| Homogeneous | funct. with | | | 22° C. | alkaline medium |
| membrane | tetraalkylammonium | | | | |
| Kostalik | PE, functionalized | 1.5 | 48 | OH⁻ form, 20° C., | Poor mechanical |
| (2010b)²⁸ | with | | | degassed water | properties, |
| Homogeneous | tetraalkylammonium | | | | WA* = 132% by |
| membrane | | | | | weight |
| Wang et al | PES, | 2.15 | 67 | OH⁻ form, 20° C., | Lack of |
| (2010b)²⁹ | functionalized | | | fully hydrated, | mechanical |
| Homogeneous | with guanidinium | | | water | stability |
| membrane | groups | | | | |
| Tanaka et al. | SPESK and | 2.54 | 50 | OH⁻ form, 30° C., | No information |
| (2010)³⁰ | fluorenyl units | | | fully hydrated, | on chemical |
| Multiblock | | | | water | stability |
| copolymer | | | | | |
| Tanaka et al. | SPESK and | 1.93 | 96 | OH⁻ form, 40° C., | Poor mechanical |
| (2011)³¹ | fluorenyl units | | | degassed, | properties, |
| Multiblock | | | | deionized water | WA = 112% by |
| copolymer | | | | | weight (30° C.) |
| Zhao et al. | PES, quaternized | 1.62 | 29 | OH⁻ form, 20° C., | n.a. for chemical |
| (2011)³² | by | | | 100% rel. | stability |
| Multiblock | benzyltrimethylammonium | | | humidity | |
| copolymer | | | | | |
| Faraj et al. | SBS-g-VBC, | 1.21 | approx. 40 | OH⁻ form, 30° C., | Poor mechanical |
| (2011)³³ | functionalized | | | fully hydrated | properties, WA |
| Multiblock | with DABCO | | | | over 160% by |
| copolymer | | | | | weight |
| Ran et al. (2012)³⁴ | Br-PPE, | 2.4 | 32 | OH⁻ form, 20° C., | Poor to moderate |
| Homogeneous | quaternized by | | | fully hydrated, | mechanical |
| membrane | 1- | | | water | properties, |
| | Methylimidazole | | | | WA = 84% by |
| | | | | | weight |
| Lin et al. (2012)³⁵ | Br-PPE, | 2.69 | 71 | OH⁻ form, 25° C., | Moderate |
| Homogeneous | functionalized | | | fully hydrated | mechanical |
| membrane | with guanidinium | | | | stability, SI = 45% |
| | groups | | | | (80° C.) |
| Wang et al. | PEEK, | approx. 1.9 | 33.4 | OH⁻ form, 25° C., | Poor to moderate |
| (2014)³⁶ | quaternized and | | | fully hydrated, | mechanical |
| Homogeneous | cross-linked by | | | water | properties, |
| membrane | DABCO | | | | WA = 88% by |
| | | | | | weight |
| Yan et al. (2014)³⁷ | PEEK, | 1.19 | 61 | OH⁻ form, 20° C., | Poor mechanical |
| Homogeneous | functionalized | | | fully hydrated, | properties, |
| membrane | with | | | water | WA = 172% by |
| | phosphonium | | | | weight |
| | groups | | | | |

DE 10 2016 007 815 A1 also describes cross-linked anion exchange blend membranes, in which halomethylated polymers, i.e. those with Hal-CH₂ group-functionalized monomer units, are also used as blend components. It is described therein that the conversion of the Hal-CH₂ groups (Hal=Cl, Br) into an anion exchange group is achieved by reaction with a tertiary amine such as trimethylamine, pyridine, pentamethylguanidine or an N-alkylated imidazole. It also describes that steric shielding of the anion exchange groups of AEM can significantly improve their alkali stability in particular, since the nucleophilic attack of the OH⁻ counterions on the quaternary ammonium group is then more difficult. However, DE 10 2016 007 815 A1 also describes that the combination of anion exchange group and polymer main chain is always relevant for improving the chemical stability of AEM, since the stability of the anion exchange group always also depends on the polymer main chain and that it is not easy to predict which polymer main chain is more stable. Another way to stabilize AEM is to crosslink them. Furthermore, DE 10 2016 007 815 A1 describes that the systematic increase in the hydrophobicity of the AEM ammonium groups is achieved by increasing the length of the alkyl chains of trimethylbenzylammonium bound to the quaternary ammonium ion via triethylbenzylammonium, tri-n-propylbenzylammonium, tri-n-butylbenzylammonium up to tri-n-pentylbenzylammonium, the relative transport number of anions with a large hydrate shell such as sulphate or fluoride ions is significantly reduced compared to anions with a smaller hydrate shell such as chloride or nitrate. Accordingly, DE 10 2016 007 815 A1 deals with such blend membranes that contain a halomethylated polymer quaternized with a sterically hindered tertiary nitrogen compound, such as quaternized chloromethylated polystyrene or quaternized bromomethylated polyphenylene oxide, as blend components.

In addition, magnetic-field-oriented, stabilized ferrocenium-based anion-exchange membranes for fuel cells have already been described (Liu, X et al., Magnetic-field-oriented mixed-valence-stabilized ferrocenium anion-exchange membranes for fuel cells. Nat Energy 7, 329-339 (2022). https://doi.org/10.1038/s41560-022-00978-y).

### SUMMARY OF THE INVENTION

The object of the present invention was to provide improved alkaline anion exchange membrane materials which do not have the disadvantages described above. A further aspect of the invention was to provide improved membrane materials with a high degree of functionalization. In particular, an object of the invention was to provide alkaline anion exchange membrane materials which have a high anion conductivity, in particular hydroxide and/or chloride conductivity, and a high chemical, thermal and/or mechanical stability. In this context, one aspect of the invention was to provide improved membrane materials with the most homogeneous possible reinforcement of the membrane. A further object of the invention was to provide improved membrane materials which are particularly suitable for use as an alkaline (anion exchanger) membrane or anion-conducting membrane, as electrode material, as electrolyte or as ionomer. A further object of the invention was to provide improved membrane materials for use in electrolysis processes, in water electrolysis processes (such as seawater, brackish water or demineralized water electrolysis), in electrodialysis, diffusion dialysis, Donnan dialysis or in fuel cells as well as in (redox) flow batteries.

The inventors of the present invention surprisingly found that by introducing an aliphatic spacer between a quaternary ammonium group [NR₃⁺] and a polystyrene-based polymer backbone, the above disadvantages, such as nucleophilic attackability, molar mass degradation, loss of conductivity, labile benzylic ammonium groups, loss of mechanical integrity, etc., can be prevented and alkali stability can be improved. In particular, it was surprisingly found that the introduction of a longer alkyl chain [—(CH₂)₃₋₂₀-] as a spacer between a quaternary ammonium group [NR₃⁺] and the polystyrene-based polymer backbone increases the conductivity. This is particularly surprising in light of the explanations in DE 10 2016 007 815 A1 on the influence of the increase in hydrophobicity due to alkyl chain extensions on the relative transport number of anions. It was also surprisingly found that the introduction of such an alkyl spacer can achieve a plasticizing effect and thus reduce the brittleness of polystyrene frameworks.

A further object of the invention was to provide anion exchange membranes that are suitable for use in redox flow batteries. For this purpose, it is necessary that the anion exchange membranes can be used in an acidic medium, as is the case, for example, in vanadium redox flow batteries, where the electrolyte has a sulphuric acid concentration of up to 4 molar (A. Chromik et al, Stability of acid-excess acid-base blend membranes in all-vanadium redox-flow batteries, Journal of Membrane Science, 2015, 476, 148-155), are stable in the long term and are also stable under the influence of the very strongly oxidizing or reducing vanadium salt electrolytes of different oxidation states (II, III, IV, V).

### DETAILED DESCRIPTION OF THE INVENTION

The objects of the present invention were surprisingly solved by providing new polymers or copolymers comprising quaternized alkane styrene monomer units of the following formula (I)

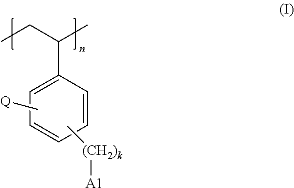

wherein with k=3 to 20 a longer alkyl chain [—(CH₂)₃₋₂₀-] is introduced as a spacer between a quaternary ammonium group [NR₃⁺] from an amine base [A1] and the polystyrene of the polymer backbone and wherein
Q=0-3 same or different substituents from the group of alkyl, alkenyl, heterocyclyl, aryl, heteroaryl, alkoxy, aryloxy, heteroaryloxy, nitro, nitroso and halogen, and
A1 is an amine base having a quaternary ammonium group [NR₃⁺], wherein R=same or different substituents selected from the group of hydrogen, alkyl, alkenyl, heterocyclyl, aryl and heteroaryl, and wherein
n denotes the degree of polymerization.

The present invention is described in more detail below and comprises in particular the following aspects:
[1]A polymer or copolymer containing quaternized alkane styrene monomer units of the following formula (I),

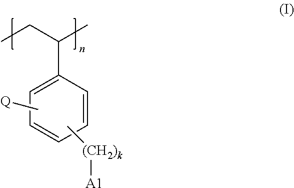

wherein
k=3 to 20;
Q=0-3 same or different substituents from the group of alkyl, alkenyl, heterocyclyl, aryl, heteroaryl, alkoxy, aryloxy, heteroaryloxy, nitro, nitroso and halogen;
A1=an amine base (comprising a quaternary ammonium group [NR₃⁺] where R=the same or different substituents selected from the group of hydrogen, alkyl, alkenyl, heterocyclyl, aryl and heteroaryl);
and where n denotes the degree of polymerization.
[2] Polymer or copolymer according to [1], wherein k is ≥4, preferably >4, more preferably >5, even more preferably ≥6.
[3] Polymer or copolymer according to [1] or [2] wherein the amine base A1 (quaternary ammonium groups NR₃⁺) are selected from the group according to the figure below “Amine bases—quaternary ammonium groups NR₃⁺”, which are bonded to the —(CH₂) spacer of the monomer unit (I) via a nitrogen atom to form a quaternary ammonium group, and mixtures thereof.
[4] Polymer or copolymer according to [1] to [3] further comprising the same or different comonomers selected from the group of styrene-based comonomers and/or from the group of vinyl monomers.
[5] Polymer or copolymer according to [1] to [4] wherein styrene-based comonomers are selected from the group comprising styrene, para-alkylstyrenes, fluorinated styrene, such as mono-, di-, tri-, tetra- and pentafluorostyrene, 4-vinylbiphenyl, norbomenes and side-chain vinylferrocenes.
[6] Polymer or copolymer according to [4] or [5], wherein
   (A) styrene-based comonomers are selected from the group according to the figure below “Styrene-based comonomers”, and
   (B) Vinyl monomers can be selected from the group according to the figure below “Comonomers from the group of vinyl monomers”.
[7] Polymer or copolymer according to [4] to [6], wherein
   (A) Styrene-based comonomers are selected from styrene, para-alkylstyrenes and 4-vinylbiphenyl,
and
   (B) Vinyl monomers are selected from 9-vinylcarbazole and vinylimidazole.
[8] Polymer or copolymer according to [1] to [7], wherein the comonomers are selected from hydrophobic comonomers, preferably selected from styrene, n-octylstyrene, mono-, di-, tri-, tetra- and pentafluorostyrene, 4-vinylbiphenyl and norbornene derivatives.
[9] Polymer or copolymer according to [1] to [8], which is linear or branched.
[10] Polymer or copolymer according to [1] to [9], which is random, alternating or a block (co-)polymer.
[11] Water-insoluble polymer membrane (AEM) containing a quaternized polymer and/or copolymer according to [1] to [10].
[12]A water-insoluble polymer membrane (AEM) according to [11], wherein the quaternized polymer and/or copolymer is characterized in that it comprises hydrophobic comonomers.
[13] Water-insoluble polymer membrane (AEM) according to [12], wherein hydrophobic comonomers are selected from the group according to the figure below “a) copolymer with styrene/alkylstyrene/arylstyrene comonomers” and b) copolymer with norbornene derivative comonomers”, preferably from styrene, n-octylstyrene and norbomene derivatives.
[14] Water-insoluble polymer membrane (AEM) according to [11] to [13], which also contains at least one chemically inert matrix polymer.
[15]A water-insoluble polymer membrane (AEM) according to [14], wherein chemically inert matrix polymers are selected from the group according to the figure below “Polybenzimidazole derivatives (PBIs)” and mixtures thereof.
[16] Water-insoluble polymer membrane (AEM) according to [14] or [15], which is present in the form of a blend of the quaternized polymers and/or copolymers and the chemically inert matrix polymers.
[17]A water-insoluble polymer membrane (AEM) according to [16], wherein the blend contains further components selected from the group comprising crosslinking agents, organic and/or inorganic nano- or microparticulate superplasticizers, fillers, carrier materials, stabilizers, phase mediators such as block copolymers, catalysts and/or dyes, and mixtures thereof.
[18] Polymer or copolymer according to [1] to [10] or water-insoluble polymer membrane (AEM) according to [11] to [17], which are present in the form of particles, granules, powders etc. or in the form of layers, films, foils or porous constructs/nonwovens.
[19] Styrene monomer according to the following formula (II-A)

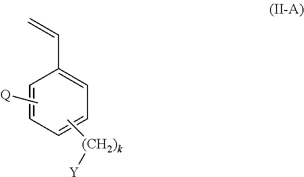

with
k=3 to 20;
Q=0-3 same or different substituents from the group of alkyl, alkenyl, heterocyclyl, aryl, heteroaryl, alkoxy, aryloxy, heteroaryloxy, nitro, nitroso and halogen;
Y=a leaving group; and
where monomers of the formula (II) where k=6 and Y═Br are excluded.
[20] Styrene monomer according to [19], wherein k is ≥4, preferably >4, more preferably >5, even more preferably ≥6.
[21] Styrene monomer according to [19] or [20], wherein Y is a leaving group selected from halogen, mesylate, triflate, tosylate, fluorosulfonates, nitrates, phosphates and nonaflates.
[22] Styrene monomer according to [21], wherein Y is selected from Cl, Br, and I, preferably Y is Cl or Br, more preferably Cl.
[23] Styrene monomer according to [19] to [22], which is 1-(6-chlorohexyl)-4-vinylbenzene:

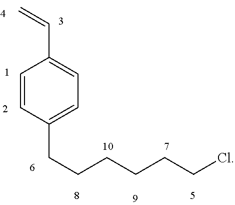

[24] Styrene monomer according to the following formula (II-B)

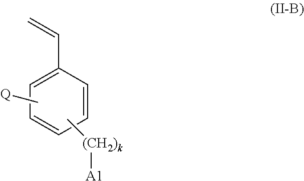

with
k=3 to 20;
Q=0-3 same or different substituents from the group of alkyl, alkenyl, heterocyclyl, aryl, heteroaryl, alkoxy, aryloxy, heteroaryloxy, nitro, nitroso and halogen; and
A1=an amine base (comprising a quaternary ammonium group [NR₃⁺] where R=the same or different substituents selected from the group of hydrogen, alkyl, alkenyl, heterocyclyl, aryl and heteroaryl).
[25] Styrene monomer according to [24], wherein the amine base A1 (quaternary ammonium group NR₃⁺) is selected from the group according to the figure below “Amine bases—Quaternary ammonium groups NR₃⁺”, which are bonded to the —(CH₂) spacer of the monomer unit (II-B) via a nitrogen atom to form a quaternary ammonium group.
[26]A polymer or copolymer containing alkane styrene monomer units of the following formula (III),

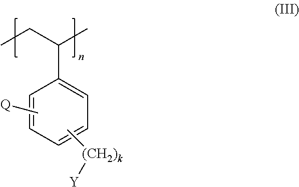

with
k=3 to 20;
Q=0-3 identical or different substituents from the group of alkyl, alkenyl, heterocyclyl, aryl, heteroaryl, alkoxy, aryloxy, heteroaryloxy, nitro, nitroso and halogen; and
Y=a leaving group;
and where n denotes the degree of polymerization.
[27] Polymer or copolymer according to [26], wherein k is ≥4, preferably >4, more preferably >5, even more preferably ≥6.
[28] Polymer or copolymer according to [26] or [27] wherein the leaving group Y is selected from halogen, mesylate, triflate, tosylate, fluorosulfonates, nitrates, phosphates and nonaflates, preferably from Cl, Br, and I, more preferably Y is Cl or Br, still more preferably Cl.
[29] Polymer or copolymer according to [26] to [28] further comprising the same or different comonomers selected from the group of styrene-based comonomers and/or from the group of vinyl monomers.
[30] Polymer or copolymer according to [29] wherein styrene-based comonomers are selected from the group comprising styrene, para-alkylstyrenes, fluorinated styrene, such as mono-, di-, tri-, tetra- and pentafluorostyrene, norbornenes and side chain vinylferrocenes.
[31] Polymer or copolymer according to [29] or [30], wherein
   (A) styrene-based comonomers are selected from the group according to the figure below “Styrene-based comonomers”, and
   (B) Vinyl monomers can be selected from the group according to the figure below “Comonomers from the group of vinyl monomers”.
[32] Polymer or copolymer according to [29] to [31], wherein
   (A) styrene-based comonomers are selected from styrene, para-alkylstyrenes and 4-vinylbiphenyl, and
   (B) Vinyl monomers are selected from 9-vinylcarbazole and vinylimidazole.
[33] Polymer or copolymer according to [26] to [32], which is linear or branched and/or which is random, alternating or a block (co-)polymer.
[34] Polymer or copolymer according to [1] to [10] or according to [26] to [33] carrying further functional groups selected from the group comprising alkyl, alkenyl, heterocyclyl, aryl, heteroaryl, alkoxy, aryloxy, heteroaryloxy, nitro, nitroso and halogen (each as defined herein) and bis(cyclopentadienyl) metal complexes.
[35] Polymer or copolymer according to [26] to [34], comprising the alkane styrene monomer units of the formula (III) and also quaternized alkane styrene monomer units of the formula (I),

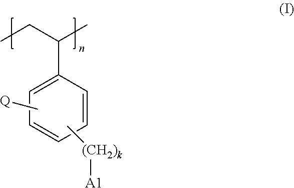

wherein
k=3 to 20;
Q=0-3 same or different substituents from the group of alkyl, alkenyl, heterocyclyl, aryl, heteroaryl, alkoxy, aryloxy, heteroaryloxy, nitro, nitroso and halogen;
A1=an amine base (comprising a quaternary ammonium group [NR₃⁺] where R=the same or different substituents selected from the group of hydrogen, alkyl, alkenyl, heterocyclyl, aryl and heteroaryl);
and wherein n denotes the degree of polymerization, and in such mixed polymers or copolymers the number n of monomer units (I) and the number n of monomer units (III) may be the same or different.
[36] Polymer or copolymer according to [1] to [10] or according to [26] to [35], which are chemically crosslinked.
[37] Use of the quaternized polymers or copolymers according to [1] to [10] and [18] or the water-insoluble polymer membrane (AEM) according to [11] to [17] and [18], as alkaline (anion exchange) membrane/as anion-conducting membrane, as binder material for the production of electrodes or catalyst layers or as electrolyte.
[38] Use of the quaternized polymers or copolymers according to [1] to [10] and [18] or the water-insoluble polymer membrane (AEM) according to [11] to [17] and [18], as alkaline (anion exchange) membrane/as anion-conducting membrane, as binder material for the production of electrodes or catalyst layers or as electrolyte, in each case in electrolysis processes, electrodialysis, (electro)diffusion dialysis, Donnan dialysis or in fuel cells.
[39] Use of the quaternized polymers or copolymers according to [1] to [10] and [18] or the water-insoluble polymer membrane (AEM) according to [11] to [17] and [18], as ionomer.
[40] Use of the quaternized polymers or copolymers according to [1] to [10] and [18] or the water-insoluble polymer membrane (AEM) according to [11] to [17] and [18], in water electrolysis processes, in fuel cells or in (redox) flow batteries.
[41] Electrodes, catalyst layer materials, fuel cells or flow batteries containing the quaternized polymers or copolymers according to [1] to [10] and [18] or the water-insoluble polymer membrane (AEM) according to [11] to [17] and [18].
[42] Process for the preparation of the polymers/co-polymers according to [1] to [10] and [18] by
   (A) polymerization of monomers according to [19] to [23] and subsequent introduction of amine bases (to introduce quaternary ammonium groups) with quaternization of the alkyl chains and release of the leaving groups Y; or
   (B) polymerization of quaternized monomers according to [24] and [25] and/or
   (C) (co)-polymerization of monomers according to [19] to [23] and quaternized monomers according to [24] and [25] and subsequent introduction of amine bases (to introduce quaternary ammonium groups) with quaternization of the alkyl chains and release of the leaving groups Y.
[43]A process according to [42], further comprising copolymerization with comonomers as defined in [4] to [8].
[44] Process according to [42] and [43], wherein the amine bases (quaternary ammonium groups) are selected from those according to the figure below “Amine bases—Quaternary ammonium groups NR₃⁺” and mixtures thereof, wherein the amine bases are attached to the —(CH₂) spacer of the monomer units via a nitrogen atom to form a quaternary ammonium group.
[45] Process for the preparation of the alkane styrene monomers of the formula (II-A) according to [19] to [23] by reaction of the starting materials

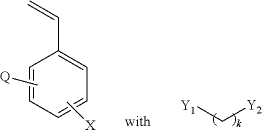

to the alkane styrene monomer (II-A)

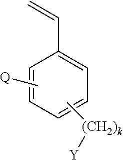

wherein
k and Q have the meaning according to [19];
X═Br, Cl, B(OH)₂, CH₂Cl; and
Y₁ and Y₂ represent the same or different leaving groups, preferably selected from halogen, mesylate, triflate, tosylate, fluorosulfonates, nitrates, phosphates and nonaflates, preferably halogen, more preferably Cl or Br, even more preferably Cl.
[46] Process for the preparation of the quaternized alkane styrene monomers of the formula (II-B) according to [24] and [25] by introducing an amine base (quaternary ammonium group) into monomers of the formula (II-A) with quaternization of the alkyl chain and release of the leaving group Y, wherein the quaternization step can be carried out subsequently to the process according to [45].
[47] Process according to [46], wherein the amine base (quaternary ammonium group) is selected from the group according to the figure below “Amine bases—Quaternary ammonium groups NR₃⁺” and mixtures thereof, wherein the amine bases are attached to the —(CH₂) spacer of the monomer units via a nitrogen atom to form a quaternary ammonium group.
[48] Process for the preparation of the water-insoluble polymer membrane according to [11] to [17], by
   (A) copolymerization of the monomers according to [24] and [25] with hydrophobic comonomers; or
   (B) blending of the polymers and/or copolymers according to [1] to [10] and [18] with at least one chemically inert matrix polymer, in particular those according to the figure below “Polybenzimidazole derivatives (PBIs)” or mixtures thereof, or
   (C) blending of the polymers and/or copolymers according to [26] to [34] or according to [35] and [36] with at least one chemically inert matrix polymer, in particular those according to the figure below “Polybenzimidazole derivatives (PBIs)” or mixtures thereof, as well as with at least one cation exchange polymer and subsequent introduction of amine bases (quaternary ammonium groups) with quaternization of the alkyl chains and release of the leaving groups Y.

As described above, the object according to the invention is achieved by functionalizing styrene monomers with longer-chain quaternized alkanes.

I. Polymers or Copolymers with Quaternized Alkane Styrene Monomer Units

The invention relates to new polymers or copolymers with quaternized alkane styrene monomer units.

The polymers or copolymers according to the invention contain quaternized alkane styrene monomer units of the following formula (I),

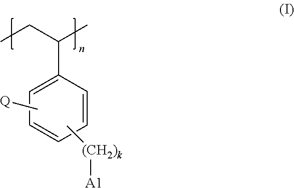

wherein k=3 to 20. Preferably k is ≥4, preferably >4, more preferably >5, even more preferably ≥6.

The styrene units according to the invention may be unsubstituted styrene (Q is absent or Q=0) or substituted styrene derivatives (Q=1, 2 or 3 same or different substituents). Possible styrene substituents “Q” can be independently selected from the group of alkyl, alkenyl, heterocyclyl, aryl, heteroaryl, alkoxy, aryloxy, heteroaryloxy, nitro, nitroso and halogen.

The amine base A1 introduces a quaternary ammonium group NR₃⁺ into the monomer unit wherein R comprises identical or different substituents from the group of hydrogen, alkyl, aryl and alkenyl. Suitable amine bases (quaternary ammonium groups NR₃⁺) can be selected from the following group, whereby the polymers/copolymers according to the invention can in principle be quaternized with the same or different amine bases (quaternary ammonium groups).

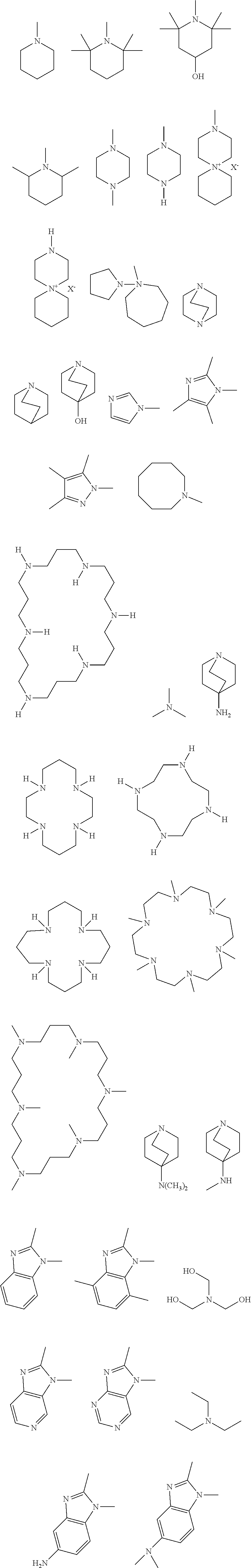

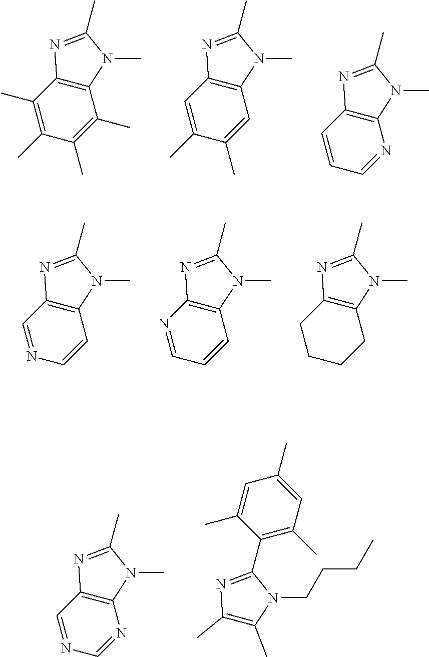

### Amine Bases—Quaternary Ammonium Groups NR₃⁺

Preferably, the amine bases are selected from the group comprising N-methylpiperidine, trimethylamine, quinuclidine, quinuclidinol, 2,3,4,5-tetramethylimidazole and 1-butyl-2-mesityl-4,5-dimethyl-1H-imidazole, of which 1-butyl-2-mesityl-4,5-dimethyl-1H-imidazole is particularly preferred:

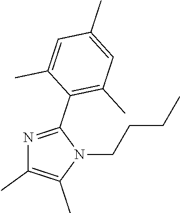 [SMILES: CCCCn1c(-c2c(C)cc(C)cc2C)nc(C)c1C]

The amine bases are bound to the —(CH₂) spacer of the monomer units via a suitable nitrogen atom to form a quaternary ammonium group.

The monomer units (I) shown above form the polymer according to the invention, where n denotes the degree of polymerization.

For the purposes of the invention, “alkyl”, in particular as substituent Q and/or R, denotes a straight-chain, branched or cyclic saturated alkyl radical having 1 to 10 carbon atoms “C₁₋₁₀-alkyl”. From the group of straight-chain or branched saturated alkyl radicals, those with 1 to 8 carbon atoms “C₁₋₈” are preferred, more preferred are those with 1 to 6 carbon atoms “C₁₋₆”, even more preferred are those with 1 to 4 carbon atoms “C₁₋₄”, the most preferred being alkyl chains with 1, 2 or 3 carbon atoms. Examples of these are methyl, ethyl, n-propyl, i-propyl, n-butyl, i-butyl, sec-butyl, t-butyl, n-pentyl, i-pentyl, sec-pentyl, t-pentyl, 2-methylbutyl, n-hexyl, 1-methylpentyl, 2-methylpentyl, 3-methylpentyl, 4-methylpentyl, 1-ethylbutyl, 2-ethylbutyl, 3-ethylbutyl, 1,1-dimethylbutyl, 2,2-dimethylbutyl, 3,3-dimethylbutyl, 1-ethyl-1-methylpropyl, n-heptyl, 1-methylhexyl, 2-methylhexyl, 3-methylhexyl, 4-methylhexyl, 5-methylhexyl, 1-ethylpentyl, 2-ethylpentyl, 3-ethylpentyl, 4-ethylpentyl, 1,1-dimethylpentyl, 2,2-dimethylpentyl, 3,3-dimethylpentyl, 4,4-dimethylpentyl, 1-propylbutyl, n-octyl, 1-methylheptyl, 2-methylheptyl, 3-methylheptyl, 4-methylheptyl, 5-methylheptyl, 6-methylheptyl, 1-ethylhexyl, 2-ethylhexyl, 3-ethylhexyl, 4-ethylhexyl, 5-ethylhexyl, 1,1-dimethylhexyl, 2,2-dimethylhexyl, 3,3-dimethylhexyl, 4,4-dimethylhexyl, 5,5-dimethylhexyl, 1-propylpentyl, 2-propylpentyl, etc. Particularly preferred are methyl, ethyl, n-propyl, i-propyl, n-butyl, i-butyl, sec-butyl, and t-butyl. More preferred are C₁-C₃-alkyl, such as methyl, ethyl and i-propyl. Even more preferred are C₁- and C₂-alkyl, such as methyl and ethyl. Cyclic saturated alkyl radicals comprise aliphatic rings with 3 to 8, preferably 5 or 6 ring carbon atoms, such as a cyclopropyl group, a cyclobutyl group, a cyclopentyl group, a cyclohexyl group, a cycloheptyl group and a cyclooctyl group.

The term “alkenyl” denotes a straight-chain or branched alkyl chain with 2 to 10 carbon atoms “C₂₋₁₀-alkenyl”, which contains at least one carbon-carbon double bond. Examples are ethenyl, propenyl, decenyl, 2-methylenehexyl and (2E,4E)-hexa-2,4-dienyl. Preferred is “C₂₋₆-alkenyl”.

The term “heterocyclyl” includes saturated or unsaturated mono- or bicyclic 4- to 8-membered heterocyclic radicals containing 1 to 3, preferably 1 to 2, identical or different heteroatoms selected from N, O and S, including azetidinyl, oxetanyl, pyrrolidinyl, pyrazolidinyl, imidazolidinyl, tetrahydrofuranyl, dioxolanyl, tetrahydrothiophenyl, oxathiolanyl, piperidinyl, piperazinyl, tetrahydropyranyl, thianyl, dithianyl, trithianyl, tetrahydrothiopyranyl, morpholinyl, thiomorpholynyl, dioxanyl, etc.

The term “aryl” refers to mono- or bicyclic aromatic hydrocarbon radicals with 6 to 14 carbon atoms (excluding the carbon atoms of possible aryl substituents), such as phenyl, naphthyl, phenanthrenyl and anthracenyl. Phenyl is preferred.

The term “heteroaryl” denotes heteroaromatic hydrocarbon radicals having 4 to 9 ring carbon atoms which additionally contain 1 to 3 identical or different heteroatoms selected from N, O, S and P in the ring and thus form 5- to 12-membered heteroaromatic radicals which may be monocyclic or bicyclic. Monocyclic heteroaryl groups preferably comprise 5- and 6-membered monocyclic heteroaryl groups, such as pyridyl (pyridinyl), pyridyl-N-oxide, pyridazinyl, pyrimidyl, pyrazinyl, thienyl (thiophenyl), furyl, pyrrolyl, pyrazolyl, imidazolyl, triazolyl, tetrazolyl, thiazolyl, isothiazolyl, oxazolyl or isoxazolyl. Examples from the group of 5-membered heteroaryls include thiazolyl, thienyl (thiophenyl), pyrazolyl, imidazolyl, triazolyl and oxazolyl. Examples from the group of 6-membered heteroaryls include pyridyl (pyridinyl), pyridazinyl, pyrimidinyl, pyrazinyl, triazinyl and phosphabenzyl. Monocyclic heteroaryl groups preferably include bicyclic heteroaryl groups include, for example, indolizinyl, indolyl, benzo[b]thienyl, benzo[b]furyl, indazolyl, quinolyl, isoquinolyl, naphthyridinyl, quinazolinyl, quinoxalinyl and benzimidazolyl.

The term “alkoxy”, “aryloxy” and “heteroaryloxy” each refers to an alkyl, aryl or heteroaryl group as defined above which is bonded via an oxygen atom, such as an [—O-alkyl], [—O-aryl]and [—O-heteroaryl]group. Examples of an alkoxy group include a methoxy, ethoxy, propoxy or isopropoxy group. Examples of an aryloxy group include a phenoxy group.

“Halogen” or “halogen atom” denotes a fluorine, chlorine, bromine or iodine atom, in particular a fluorine, chlorine or bromine atom, with chlorine and bromine being particularly preferred. Chlorine is particularly preferred.

The term “nitro” or “nitro group” refers to the functional NO₂ group that is bound via the nitrogen atom [—NO₂].

The term “nitroso” or “nitroso group” refers to the functional nitroso group —N═O, which is bound via the nitrogen atom [—N═O].

The indices n and m used in the representation of monomer units, polymers and copolymers denote the degree of polymerization. In a polymer/copolymer, the respective indices can represent the same or different integer values.

In principle, the polymers described here can be composed of the monomer units (I) shown above and form homopolymers accordingly. It is also possible, and preferred according to the invention, to form copolymers with 1 to 99 mol % of the same or different comonomers. It is noted for the avoidance of doubt that such comonomers have a different structure from the monomer units (I).

Comonomers for forming the polymers or copolymers according to the invention are preferably selected from the group of styrene-based monomers and/or from the group of vinyl monomers. Examples of possible styrene-based comonomers include

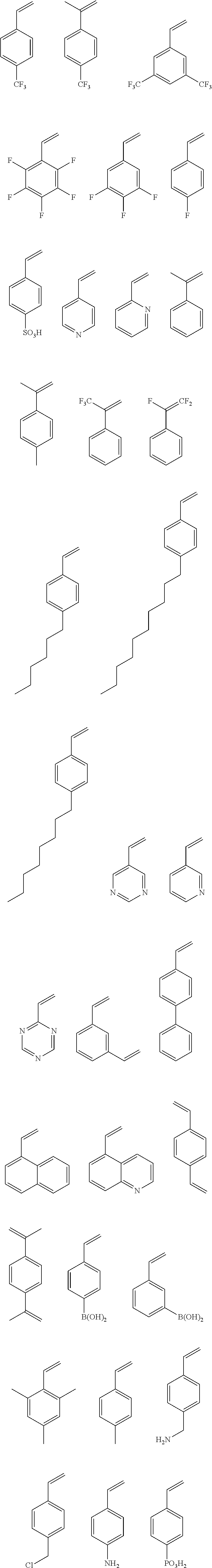

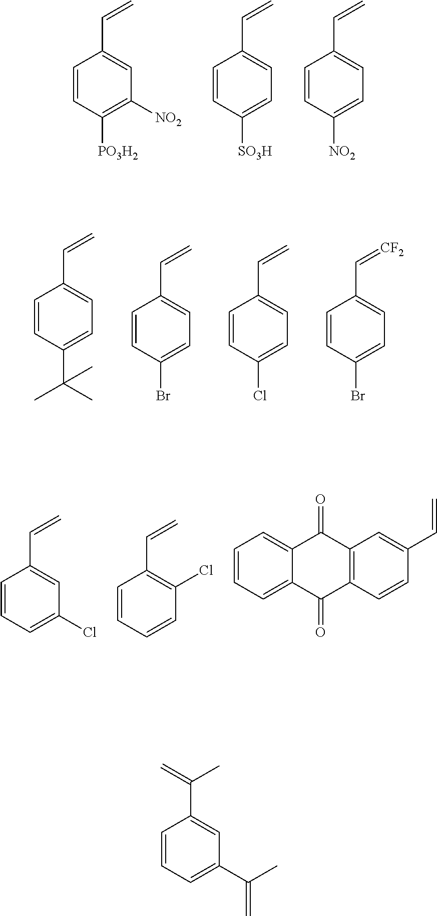

### Styrene-Based Comonomers

Examples of possible comonomers from the group of vinyl monomers include

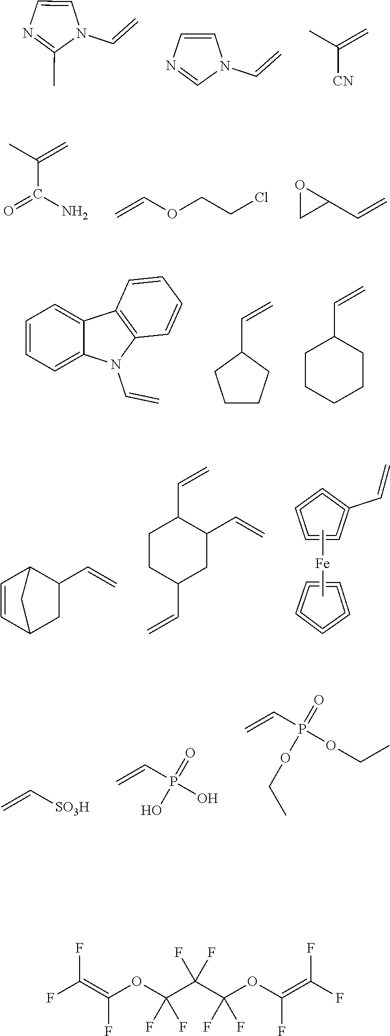

### Comonomers from the Vinyl Monomer Group

Preferred styrene-based comonomers are selected from the group comprising styrene, para-alkylstyrenes, fluorinated styrene, such as mono-, di-, tri-, tetra- and pentafluorostyrene, of which pentafluorostyrene is particularly preferred, and norbornenes and side-chain vinyl ferrocenes.

Particularly preferred styrene-based comonomers are selected from styrene, para-alkylstyrenes and 4-vinylbiphenyl.

Particularly preferred comonomers from the group of vinyl monomers are selected from 9-vinylcarbazole and vinylimidazole.

In a further aspect of the invention, comonomers which are hydrophobic are preferably selected, such as particularly preferably styrene, n-octylstyrene, mono-, di-, tri-, tetra- and pentafluorostyrene, 4-vinylbiphenyl and norbonene derivatives. The copolymers formed therefrom can be represented by the following structure:

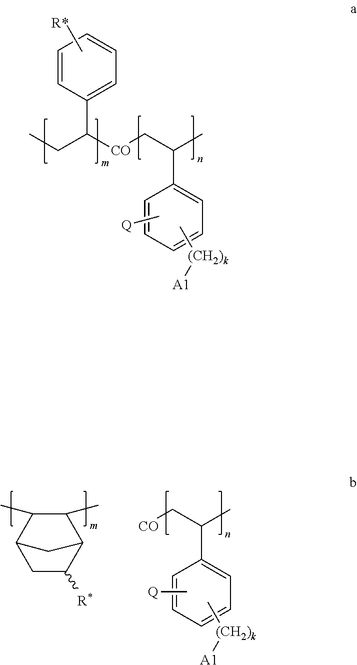

k, A1 and Q=as defined herein
R*═H, alkyl or aryl (as defined above)
m and n denote the degree of polymerization and can be the same or different
   “a. Copolymer with styrene/alkylstyrene/arylstyrene comonomers”
   “b. Copolymer with norbornene derivative comonomers”

The above-mentioned pentafluorostyrene styrene comonomers, which are particularly preferable for use, can be synthetically functionalized and/or functionalized after copolymerization. These are particularly suitable for the production of the copolymers according to the invention, as they can reduce the water absorption of the polymers. This is also possible with other fluorine-containing styrene comonomers, such as mono-, di-, tri- and tetrafluorostyrene (according to the above figure “Styrene-based comonomers”). The applicability of the styrene-based comonomers described herein as well as of comonomers from the group of vinyl monomers, such as in particular vinylimidazole or 9-vinylcarbazole, in copolymerization with the monomers according to the invention described herein enables a high synthetic flexibility in the production of new functional materials characterized by the monomer units according to the invention.

The polymers or copolymers according to the invention can be linear or branched.

The polymers or copolymers according to the invention can be random, alternating or block (co-)polymers. Preferred are random copolymers. Insofar as polymers/copolymers shown herein are characterized by an abbreviation or a structural symbol “co”, this generally refers to a copolymer which can be a random, alternating or block (co-)polymer.

Surprisingly, it was found that the copolymers obtained by random copolymerization of the styrene monomers according to the invention (described in more detail below) with styrene-based comonomers already exhibited high conductivity and good mechanical stability in pure form and are therefore directly suitable as anion exchange membranes and can be used accordingly.

In addition, it was surprisingly found that when using di- and/or trivinyl comonomers, such as divinylbenzene, trivinylcyclohexane, diisopropenylbenzene (according to the above figures “styrene-based comonomers” or “comonomers from the group of vinyl monomers”), the mechanical stability of the polymer membranes could be significantly increased.

Particularly preferred polymers/copolymers according to the invention are selected from the group comprising:

| Structure | Designation |
|---|---|
| 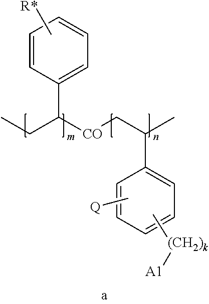 | Copolymers of quaternized styrene monomers with styrene or |
| with | |
| R* = H or alkyl or aryl (as defined above) | |
| k = 3-20 | |
| A1 = Amine base (as defined above) | |
| Q = styrene substituent (as defined above) | |
| m and n = degree of polymerization (equal or different) | |
| 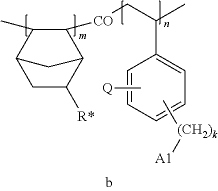 | Copolymers of quaternized styrene monomers with norbornene derivatives |
| with | |
| R* = H or alkyl or aryl (as defined above) | |
| k = 3-20 | |
| A1 = Amine base (as defined above) | |
| Q = styrene substituent (as defined above) | |
| m and n = degree of polymerization (equal or different) | |
| 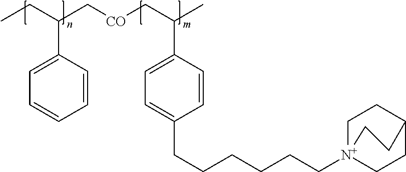 | Quinuclidine-quaternized copolymer of 1-(6-chlorohexyl)-4-vinylbenzene and styrene |
| 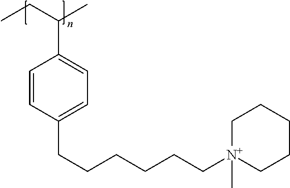 | 1-Methyl 1-(6-(4- vinylphenyl)hexyl)piperidine-1-ium bromide polymer |

The quaternized polymers/copolymers according to the invention are also referred to as anion exchange polymers.

The polymers/copolymers (I) according to the invention may carry further functional groups, such as those selected from the group comprising alkyl, alkenyl, heterocyclyl, aryl, heteroaryl, alkoxy, aryloxy, heteroaryloxy, nitro, nitroso and halogen (each as defined above) and bis(cyclopentadienyl) metal complexes.

The polymers/copolymers according to the invention (I) can also be additionally chemically crosslinked. For example, by diamines such as 1,4-diazabicyclo[2.2.2]octane, N,N,N′,N′-tetramethyl-1,6-hexanediamine, N,N,N′,N′-tetramethyl-1,4-butanediamine, N,N,N′,N′-tetramethyl-1,3-propanediamine, bis-[2-(N,N-dimethylamino)-ethyl]-ether.

### II. AEM Polymer Membrane

As shown above, the polymers/copolymers according to the invention with quaternized alkane styrene monomer units are suitable as alkaline anion exchange membrane materials due to their advantageous properties. For use as a membrane, it is necessary for the polymers/copolymers described above to be water-insoluble (hydrophobic) or to be converted into a water-insoluble (hydrophobic) form.

This can be achieved by specifically selecting hydrophobic comonomers, such as styrene, n-octylstyrene, 4-vinylbiphenyl or norbomene derivatives, for the preparation of copolymers of the monomer units (I) of the invention described above (S. I. Chowdhury et al., Copolymerization of Norbornene and Styrene with Anilinonaphthoquinone-Ligated Nickel Complexes, Polymers, 2019, 11. DOI 10.3390/polym11071100; Liu et al., 2018). In addition, a large number of other comonomers, for example from the group of vinyl monomers described above, are suitable for copolymerization with the monomer units (I) according to the invention, such as in particular the groups described above. As already described above, monomers according to the invention copolymerized with hydrophobic comonomers can also be used per se, i.e. already in their pure form, as alkaline anion exchange membranes.

In a further aspect of the invention, additional reinforcements are provided to the quaternized polymers/copolymers or AEMs according to the invention. Possible reinforcements comprise, for example, modifications of the quaternized polymers/copolymers or AEMs by
a) mixing (blending) with chemically inert matrix polymers
b) covalent crosslinking of the polymers according to the invention with crosslinking reagents,
c) cross-linking by non-covalent interactions, including ionic interactions, dipole-dipole interactions, H-bridge interactions and van der Waals interactions with a physicochemical reactant,
d) Reinforcement through the addition of chemically inert particles, fibers or braids.

Combinations of the aforementioned reinforcement measures are also possible.

Reinforcing measures according to the aforementioned option a) are particularly preferred and represent a specific aspect of the aforementioned invention. Among these, in a particularly preferred aspect of the invention, the quaternized polymers/copolymers according to the invention are converted into a hydrophobic form by blending (mixing) with a stable or inert matrix polymer, thereby obtaining alkaline anion exchange membranes in the form of so-called blend membranes.

Surprisingly, the quaternized polymers/copolymers according to the invention showed excellent miscibility with polybenzimidazole derivatives (PBIs), which are thus well suited as stable, inert matrix polymers. Examples of matrix polymers from the group of PBIs include those from the following group:

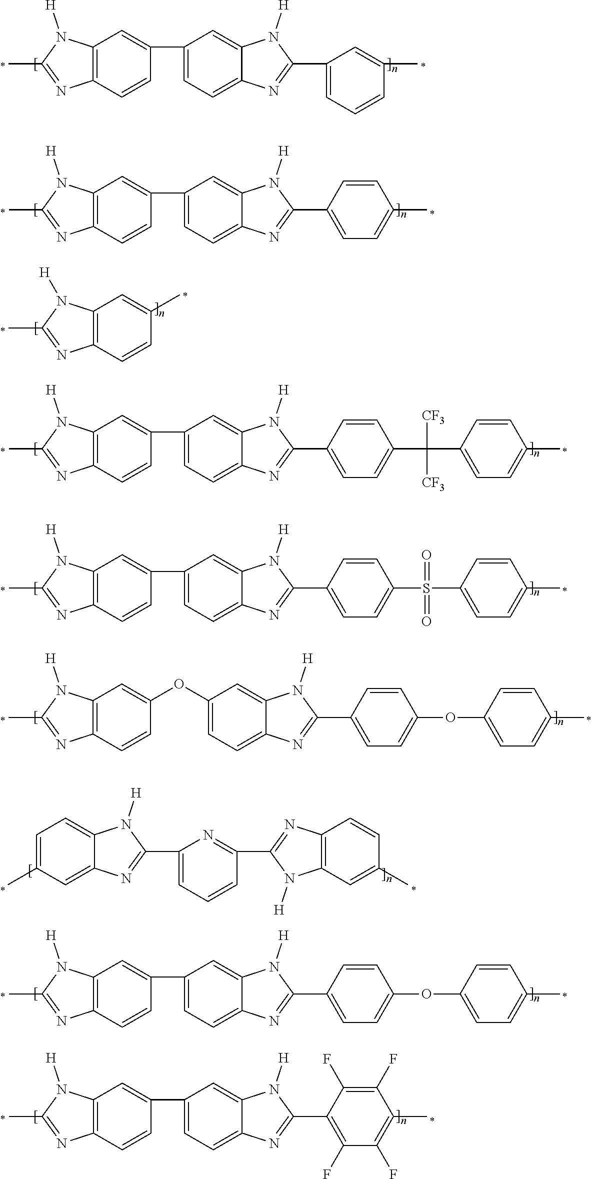

### Polybenzimidazole Derivatives (PBIs)

Other N-based polymers such as polymers with pyridine units are also suitable as matrix polymers.

It was surprising that in such a blend membrane, even water-soluble polymers/copolymers become sufficiently water-insoluble or hydrophobic to be suitable as AEMs simply by blending (mixing) with suitable matrix polymers described above. It is assumed that this is based on a similar principle to the so-called snake cage polymers (also known as the “snake in the cage” principle), as described in DE2338755A1, for example.

The invention therefore also relates to novel alkaline anion exchange membranes (AEM polymer membranes) comprising the polymers or copolymers with quaternized alkane styrene monomer units according to the preceding first aspect of the invention. Such AEMs according to the invention are in particular water-insoluble polymer membranes (AEM) comprising the quaternized polymers and/or copolymers according to the invention.

For the purposes of the present invention, a polymer/copolymer is regarded as water-insoluble if the polymer/copolymer absorbs less than 400 percent by weight of water, based on its own weight (dry weight of the polymer).

Water-insoluble polymer membranes (AEM) according to the invention are thus characterized either by the fact that they comprise quaternized copolymers with hydrophobic comonomers according to the invention, for example those from the group styrene, n-octylstyrene, 4-vinylbiphenyl and norbomene derivatives, and/or that they are present (in particular in the case of hydrophilic/water-soluble polymers/copolymers) in the form of a blend with at least one chemically inert matrix polymer.

Chemically inert matrix polymers for blend membranes according to the invention can be selected from the group of possible PBIs shown above. It is of course also possible to select mixtures of the PBIs shown above or of PBIs with other suitable matrix polymers.

Such blend membranes represent a particularly preferred aspect of the invention. A particular advantage of such blend membranes is also to be seen in the fact that a particularly homogeneous amplification can be achieved by this type of modification due to the production of a physical, homogeneous mixture. This has a particularly beneficial effect on stability. Pure cross-linking, on the other hand, generally only achieves heterogeneous reinforcement.

Hydrophobic polymer membranes (AEMs) according to the invention, which are present in the form of blend membranes, can also contain other components in the blend. Possible examples of further blend components include crosslinking agents, organic and/or inorganic nano- or microparticulate flow agents, fillers, carrier materials, stabilizers, dyes, phase mediators such as block copolymers and other suitable auxiliaries and additives. It is possible to add individual components or mixtures of components from one or more of these groups.

The hydrophobic polymer membranes (AEMs) according to the invention, either in the form of water-insoluble polymers/copolymers according to the invention or in the form of blend membranes, can be present in the form of powders, particles, granules, etc. (physical mixtures or powder blends) or in the form of (cast) layers, blocks, films, foils or as porous constructs or nonwovens.

An example of a particularly preferred blend membrane comprises homopolymers of 1-methyl-1-(6-(4-vinylphenyl)hexyl)piperidine-1-ium bromide having the structure shown above and poly[2,2′-(p-oxydiphenylene)-5,5′ bibenzimidazole](O-PBI) as matrix polymer.

In a further aspect of the invention, the water-insoluble polymer membranes (AEM) can be reinforced by crosslinking and are then present as crosslinked polymers or copolymers. Cross-linked polymers or copolymers refers to the polymers or copolymers according to the invention in which the linear polymer chains in the polymer backbone are cross-linked with each other by a cross-linking reagent.

interactions, dipole-dipole interactions, hydrogen bonds or van der Waals interactions. Ionic cross-linking effects occur, for example, through attractive interactions between the quaternized ammonium groups and their anionic counterions in the polymer backbone. A further cross-linking effect can also be achieved by charged hydrogen bonds between the quaternized ammonium groups and suitable molecular residues, e.g. in norbomene-based comonomer units. Hydrogen bonds can be formed, for example, between donor hydrogen atoms from chemically inert matrix polymers such as polybenzimidazloene to acceptors according to the invention in the form of oxygens from polyether chains. Dipole-dipole interactions occur between all polar components and van der Waals interactions generally occur between all species introduced into the membrane.

The quaternized polymers/copolymers according to the invention and/or the water-insoluble polymer membranes according to the invention are characterized by at least one, preferably by a combination of at least two of the properties described below.

### Ion Exchange Capacity (IEC)

A high ion exchange capacity (IEC) is essential for use as an anion exchange membrane. According to the invention, an IEC of 0.5 to 3.5 mmol/g, preferably of 1.0 to 3.0 mmol/g, more preferably of 2.0-2.5 mmol/g can be obtained.

The ion exchange capacity is preferably determined by determining the chloride or bromide content using Mohr titration.

### Anion Conductivity

A high anion conductivity is also important for the AEM applications according to the invention.

The quaternized polymers/copolymers or hydrophobic anion exchange polymer membranes according to the invention are characterized by a high hydroxide conductivity. According to the invention, this is preferably in the range of at least 2-250 mS/cm, in a temperature range of 20° C. to 100° C. A hydroxide conductivity of at least 50 mS/cm, or even at least 100 mS/cm, is preferred.

According to the invention, the chloride conductivity is preferably in the range of at least 2-100 mS/cm. A chloride conductivity of at least 10 mS/cm, more preferably of at least 50 mS/cm, even more preferably of at least 75 mS/cm is particularly advantageous.

The hydroxide and chloride conductivity is preferably determined using electrochemical impedance spectroscopy, as described in more detail in the example section.

Preferred copolymers according to the invention, such as those according to structures a) and b) shown above

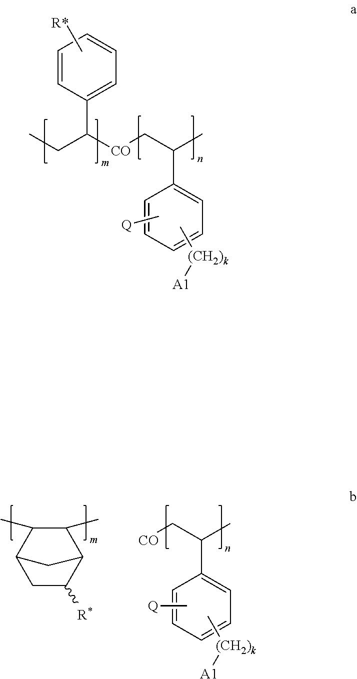

k, A1 and Q=as defined herein
R*═H, alkyl or aryl (as defined above)
m and n denote the degree of polymerization and can be the same or different
   or those according to the following structure

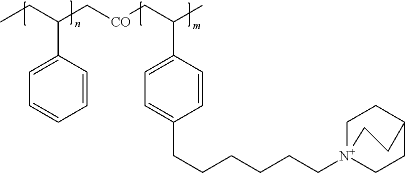

for example, have an ion exchange capacity of 1.80 mmol/g and showed a chloride conductivity between 13.4 and 52.0 mS/cm at room temperature and membrane thicknesses between 40 and 80 μm.

Preferred blend membranes according to the invention of homopolymers of 1-methyl-1-(6-(4-vinylphenyl)hexyl)piperidine-1-ium bromide with the structure shown above (thickness 20 to 60) with poly[2,2′-(p-oxydiphenylene)-5,5′-bibenzimidazole](O-PBI) (IEC 2.00-2.40 mmol/g) showed conductivities between 2.3 and 20.8 mS/cm (depending on IEC) in chloride form. Under alkaline electrolysis conditions (1 M KOH as electrolyte, 70° C.), the conductivity is correspondingly higher.

### Stability

For use in alkaline electrolysis and as alkaline fuel cells etc., the polymers also need to be highly stable.

On the one hand, stability refers to thermal stability, which can be determined using thermogravimetry (TGA). The decomposition point is usually defined as the temperature at which 5% by weight of the original mass is lost. The polymers and copolymers according to the invention showed decomposition points between 250° C. and 400° C., which means that they can be regarded as sufficiently thermally stable for the processes described above.

The mechanical stability of the polymers according to the invention can be determined by dynamic mechanical analysis (DMA) by measurement in a humidity chamber.

The alkali stability (or OH⁻ stability) can be determined by placing the membrane in an alkaline solution (e.g. 1M KOH) at a controlled temperature (e.g. 90° C.) for a predetermined period of time and examining the changes over time, for example the TGA curves, IEC, conductivity or using NMR spectroscopy.

### III. Manufacturing Process

The quaternized alkane styrene polymers or copolymers according to the invention can be obtained by targeted functionalization of styrene monomers with alkanes having a suitable leaving group (“Y”) and quaternization of the alkane chain by replacing the leaving group Y with an amine base to introduce a quaternary ammonium group.

Using standard protocols for styrene polymerization, styrene monomers can first be converted into precursor polymers, which are then converted into the anion exchange polymers by a quaternization reaction with amine bases (e.g. Menschutkin reaction). Possible variants of styrene polymerization include free radical polymerization including emulsion and suspension polymerization, reversible addition-fragmentation chain transfer polymerization (RAFT), atom transfer radical polymerization (ATRP), nitroxide-mediated polymerization (NMP) and metallocene-catalyzed polymerization.

For example, the production of precursor copolymers from a styrene with an alkyl side chain carrying a halogen as leaving group Y and a norbornene is possible analogous to the study by Chowdhury et al., 2019, in which the production of copolymers from styrene and norbomene with a nickel catalyst is described.

The synthesis of the quaternized polymers/copolymers according to the invention with the alkane styrene monomer units can be described as follows:

### Step 1—Preparation of the Y-Substituted Starting Monomers:

Styrene derivatives which have an alkyl chain [—(CH₂)ₖ—Y]substituted with a leaving group Y can be used as starting monomers. Such starting monomers can be represented by the formula (II-A):

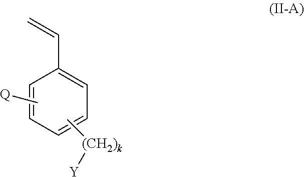

wherein
k=3 to 20 and
Q=0-3 identical or different substituents selected from the group of alkyl, alkenyl, heterocyclyl, aryl, heteroaryl, alkoxy, aryloxy, heteroaryloxy, nitro, nitroso and halogen (each as defined above), and
Y=the leaving group.

Suitable leaving groups “Y” include halogens, such as F, Cl, Br, I, or mesylate, triflate, tosylate, fluorosulfonates, nitrates, phosphates, nonaflates. Preferred leaving groups are selected from the group comprising Cl and Br, with Cl being particularly preferred.

These starting monomers (II-A) can be prepared, for example, by reacting a styrene compound with a functional group, e.g. halogen, boronic acid or a chloromethyl group, with a bifunctional compound in a coupling reaction. Possible bifunctional compounds include, for example, those from the group of dihaloalkanes, such as dibromoalkanes, diiodoalkanes and mixed dihaloalkanes such as alpha, omega-chlorobromoalkanes, chloroiodoalkanes and bromoiodoalkanes, or tosylated, mesylated alcohols or alcohols provided with triflate groups. The formation of such starting monomers (II-A), which have the alkyl spacer provided with a leaving group, from functionalized styrene and a bifunctional compound is illustrated schematically in the following diagram

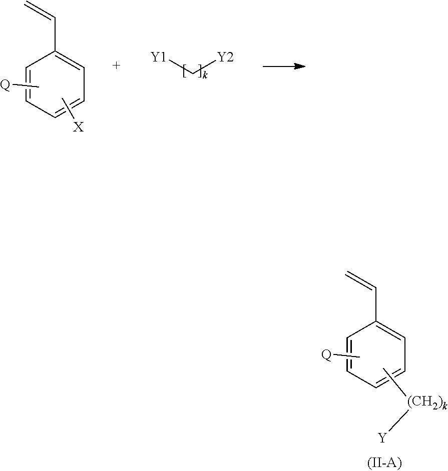

wherein
X has the meaning of halogen (such as Br, Cl), B(OH)₂, CH₂Cl;
Y₁ and Y₂ represent the same or different outlet groups as defined herein;
Y represents a leaving group as defined herein;
k=3-20 means and
Q represents the styrene substituent as defined herein.

The coupling of the styrene compound with the bifunctional compound is preferably carried out by a transition metal-catalyzed coupling reaction, with possible catalysts including Cu, Ni, Pd, Pt catalysts. Suitable catalysts are generally known. Preferred are cuprates such as Li₂CuCl₂, LiCuBr₂, Li₂CuCl₄ or palladium complexes such as [Pd(PPh₃)₃] or nickel complexes such as NiCl₂-1,1′-bis(diphenylphosphino)ferrocene.

Depending on the coupling reaction used, it may be necessary to convert the Y-alkyl-substituted styrene, for example in cases where Y=halogen, into the corresponding Grignard compound.

In this way, for example, the preferred monomer 1-(6-chlorohexyl)-4-vinylbenzene according to the invention can also be produced.

Following the conversion of the Y-alkyl-substituted styrene into a Grignard compound, the coupling reaction with the bifunctional compound is carried out under catalysis with the catalysts described above. The monomer building blocks (II-A) obtained in this way can either be reacted in a further step to give the preferred polymers according to the invention, with quaternization then taking place after polymerization. Furthermore, the monomer building blocks (II-A) can be quaternized to give the preferred monomers (II-B) according to the invention, the polymerization then taking place after the quaternization.

Step 2 (Variant a)—Production of Quaternized Polymers (I) via Quaternized Starting Monomers (II-B)

For this purpose, in a first variant (a), the monomers (II-A) can first be converted into quaternized monomers (II-B). Such quaternized starting monomers can be represented by the formula (II-B):

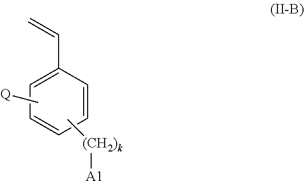

wherein
k=3 to 20 and
Q=0-3 same or different substituents from the group of alkyl, alkenyl, heterocyclyl, aryl, heteroaryl, alkoxy, aryloxy, heteroaryloxy, nitro, nitroso and halogen, and
A1=an amine base (comprising a quaternary ammonium group [NR₃] where R=the same or different substituents selected from the group of hydrogen, alkyl, alkenyl, heterocyclyl, aryl and heteroaryl as defined above).

These quaternized monomers are then polymerized to form the quaternized polymers (I) according to the invention. The process steps of variant 2-a are described below:

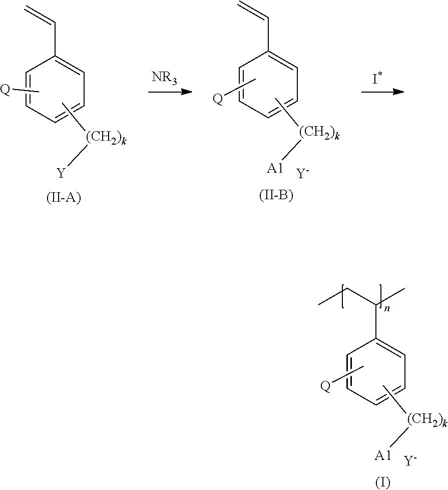

(wherein Q, Y, A1, k and n have the meanings described herein and I* is a radical initiator). In order to convert the leaving group Y, which is bound to the introduced alkyl spacer [—(CH₂)ₖ—], into a quaternary ammonium group prior to polymerization, a Menschutkin reaction can be carried out. Tertiary N-basic compounds (amine bases) such as, for example, N-methylpiperidine, trimethylamine, quinuclidine or quinuclidinol or 2,3,4,5-tetramethylimidazole, or 1-butyl-2-mesityl-4,5-dimethyl-1H-imidazole as amine base (quaternary ammonium group) are particularly suitable for this purpose.
Step 2 (Variant b)—Production of Quaternized Polymers (I) by Downstream Polymer Quaternization

In a second variant (b), the Y-functionalized monomers (II-A) are first polymerized, for example by radical polymerization, and the Y-substituted polymers thus obtained, also referred to herein as precursor polymers (III), are subsequently quaternized on the alkyl chains by introducing amine bases (to introduce quaternary ammonium groups) and releasing the leaving groups Y, as shown below:

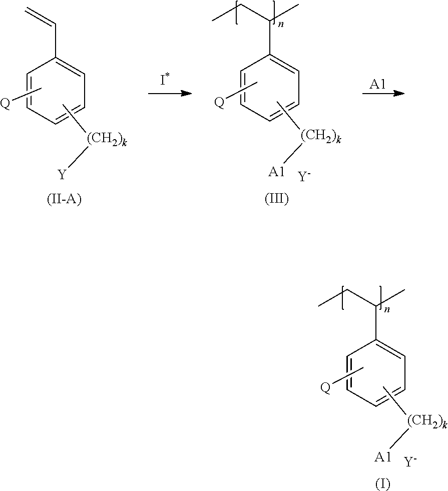

(wherein Q, Y, A1, k and n have the meanings described herein and I* is a radical initiator).
   Step 2 (Variant c)—Production of Quaternized Polymers (I) by Downstream Polymer Quaternization

In a third variant (c) of step 2, a mixture of the monomers (II-A) and (II-B) can also be polymerized as described above, resulting in so-called mixed precursor polymers or precursor copolymers with Y-functionalized alkane styrene monomer units and quaternized alkane styrene monomer units. In these mixed precursor polymers, a downstream quaternization is then carried out on the alkyl chains that are still Y-functionalized by introducing amine bases (to introduce quaternary ammonium groups) and releasing the remaining leaving groups Y, analogous to variant b described above.

For the polymerizations described above, free radical or controlled radical (ATRP, RAFT, NMP) polymerization variants or protocols are preferably used. A RAFT polymerization of the monomers according to the invention can be illustrated as follows:

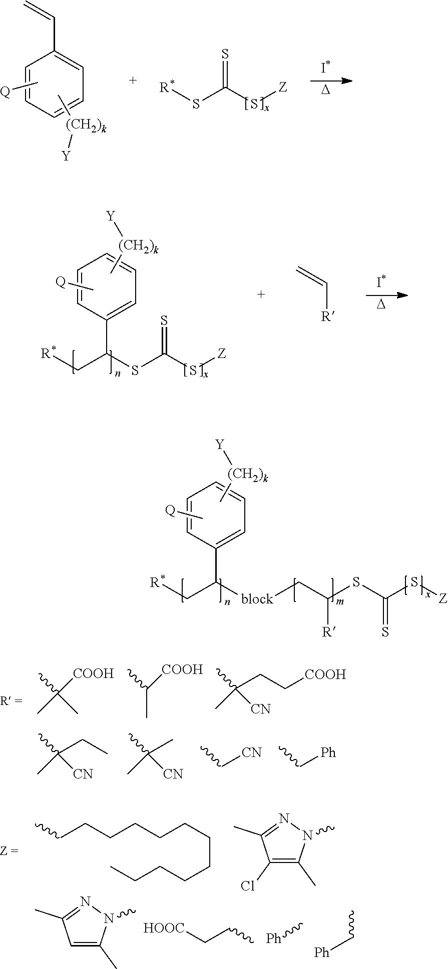

(wherein Q, Y, k and n are as defined herein, I* represents a radical initiator x=0 or 1, R′ represents the respective residues of the styrene-based comonomers and vinyl monomers described herein, and R* and Z are as defined above).

In principle, there are no restrictions on the selection of tertiary N-bases for quaternization and the amine bases defined herein (quaternary ammonium groups —NR₃⁺) can be used. It is also possible to use mixtures of different tertiary N-basic compounds (amine bases/quaternary ammonium groups) for quaternization.

The polymerization of the monomers takes place in a suitable solvent. Examples include, for example, toluene, DMF, DMAc, 1,2-dichlorobenzene, chlorobenzene, benzene, THF, DMSO, N-metyhlpyrrolidone and mixtures thereof.

Known and suitable radical initiators (1*) include, for example, azobisisobutyronitrile, benzoyl peroxide, 2,2′-azobis-(2-methyl-propionamidine)-dihydrochloride, 1,1′-azobis(cyclohexane carbonitrile), 4,4′-azobis-(4-cyano-valeric acid), 2,2′-azobis(2-methylbutyronitrile).

Alternatively, free radical polymerization can also be carried out in bulk (i.e. without solvent).

Polymerization takes place by heating to 30 to 150° C. (depending on initiator and solvent) for 2 to 72 h (depending on solvent, initiator and temperature).

In addition, the polymerizations can also be carried out in the microwave. It is known from the literature that when carrying out radical polymerizations in a microwave reactor, the reaction speed can be considerably accelerated compared to the conventional method, which leads to a significant reduction in costs (K. Kempe et al, Microwave-Assisted Polymerizations: Recent Status and Future Perspectives, Macromolecules, 2011, 44, 5825-5842).

The polymer is isolated by precipitation in a suitable precipitating agent such as MeOH, isopropanol, ethanol, water, hexane, diethyl ether or tert-butyl methyl ether.

In principle, the process described herein is suitable for the production of homopolymers in which the monomer building blocks described above are polymerized.

It is also possible and preferred according to the invention to produce copolymers in which different monomer building blocks are polymerized. The copolymerization is carried out analogously to the processes described above with a suitable comonomer as defined herein by adding a comonomer in addition to the radical initiator, the monomer according to the invention (II-A) and/or (II-B) and the solvent. The other parameters of the polymerization correspond to the procedure described above.

In the case of RAFT polymerization (Reversible Addition-Fragmentation Chain Transfer Polymerization), a RAFT agent such as 2-(dodecylthiocarbonothioylthio)-2-methylpropanoic acid, 4-cyano-4-[(dodecylsulfanylthiocarbonyl)-sulfanyl]-pentanoic acid, 4-cyano-4-(thiobenzoylthio)-pentanoic acid or 4-cyano-4-(phenylcarbonothioylthio)pentanoic acid, N-succinimidyl ester is added in addition to the solvent and radical initiator.

RAFT can also be carried out in mass without solvents. The other conditions (such as temperature, time, microwave suitability, etc.) are identical to free radical polymerization. RAFT polymerization is particularly suitable for the production of block copolymers (B. Hazer et al., Synthesis of block/graft copolymers based on vinyl benzyl chloride via reversible addition fragmentation chain transfer (RAFT) polymerization using the carboxylic acid functionalized Trithiocarbonate, J Polym Res, 2019, 26. DOL 10.1007/s10965-019-1763-z.), by polymerizing the first monomer (e.g. the preferred monomer according to the invention) after the polymerization of the second monomer (e.g. the preferred monomer according to the invention). e.g. the preferred 1-(6-chlorohexyl)-4-vinylbenzene according to the invention), a second monomer (comonomer) such as styrene or other of the comonomers defined herein is added and heated again in a suitable solvent to the respective temperature (B. Hazer et al, 2019). A reverse order of the respective comonomer polymerizations is also possible.

Furthermore, controlled radical polymerization of the monomers according to the invention is possible by means of nitroxide-mediated radical polymerization (NMP) (S. H. Kim et al. Characterization of poly(styrene-b-vinylbenzylphosphonic acid) copolymer by titration and thermal analysis, Macromol. Res., 2007, 15, 587-594), which can be represented as follows:

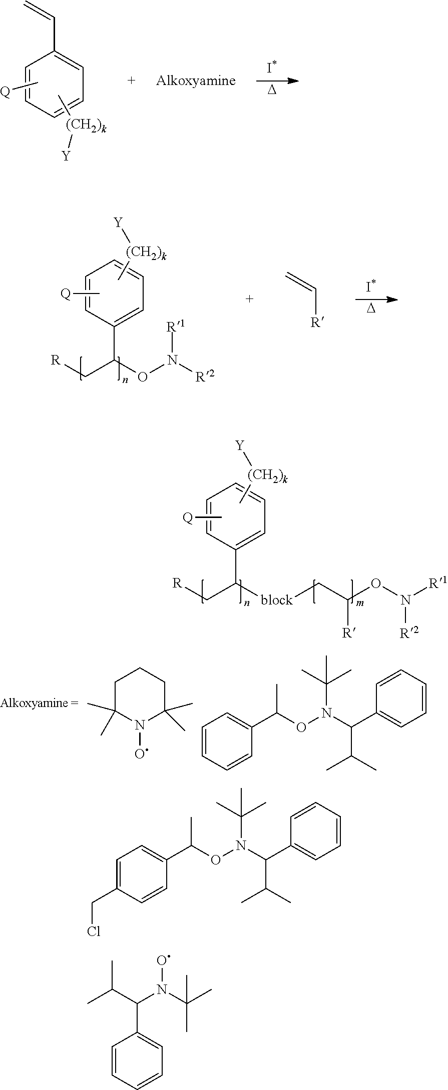

(wherein Q, Y, k and n have the meanings described herein, I* represents a radical initiator, R′ represents the respective residues of the styrene-based comonomers and vinyl monomers described herein and “alkoxyamines” denotes one of the compounds shown above which are bonded via the —O—NR′¹R′² group).

In an exemplary polymerization using NMP, for example, the monomer (II-A) 1-(6-chlorohexyl)-4-vinylbenzene according to the invention can be reacted in the presence of a radical initiator (e.g. dibenzoyl peroxide) and in a solvent (e.g. anisole). The radical initiator and the solvent are not absolutely necessary. A stabilized radical such as 2,2,6,6-tetramethylpiperidinyloxyl (TEMPO) or other alkoxyamines that form stable radicals as illustrated above is crucial for the NMP. Polymerization takes place at temperatures between 8° and 200° C. for 5 to 48 hours. Analogous to RAFT polymerization, the synthesis of block copolymers is possible by the addition of a comonomer (e.g. styrene another of the monomers defined herein) after isolation of the first block and renewed application of the polymerization protocoljust described (Kim et al., 2007). The reverse order of comonomer polymerization can also be performed.

### Quaternization/Introduction of the Quaternary Ammonium Group

In process variants in which precursor polymers with Y-substituted alkyl chains (pure Y-substituted precursor polymers or mixed precursor polymers) are first prepared, the quaternary ammonium group can be introduced into the polymer, for example by dissolving the resulting precursor polymer in a suitable solvent, e.g. THF, DMF, DMAc, chloroform, toluene, DMSO, chlorobenzene, 1,2-dichlorobenzene, followed by the addition of an amine base. e.g. selected from THF, DMF, DMAc, chloroform, toluene, DMSO, chlorobenzene, 1,2-dichlorobenzene and subsequent addition of an amine base such as quinuclidine, 1-butyl-2-mesityl-4,5-dimethyl-1H-imidazole or other amine bases as shown above as “Amine bases—Quaternary ammonium groups NR₃⁺”. The quaternization reaction can take place at a temperature between 25 and 150° C. and a reaction time of 1 to 7 days (depending on the base used).

It was found that functionalization levels of almost 100% are possible. The reaction time of the quaternization can be considerably shortened if the microwave is operated above the boiling point of the respective solvent.

For quaternization of Y-substituted mixed precursor polymers according to process variant 2-c described above, the remaining Y leaving groups in the polymer/copolymer can be cross-linked with a bifunctional amine base (e.g. 1,4-diazabicyclo[2.2.2]octane or N,N,N,N′,N′-tetramethyl-1,6-hexanediamine or others described herein) (F. Arslan et al, Performance of Quaternized Polybenzimidazole-Cross-Linked Poly(vinylbenzyl chloride) Membranes in HT-PEMFCs, ACS applied materials & interfaces, 2021, 13, 56584-56596).

The quaternization of the monomers according to process variant 2-a can be carried out analogously, whereby ethyl acetate or acetonitrile are particularly suitable as solvents.

For the polymerization of quaternized monomers (II-B) according to process variant 2-a, the polymerization conditions must be adapted. The quaternized monomer is dissolved in a mixture of solvent and water. A suitable initiator is then added and the mixture is stirred at 40 to 90° C. for 3 to 48 hours. The product can be isolated by freeze-drying after dialysis against water.

The process for the preparation of polymers/copolymers according to the invention as described herein can be described by the following features
(A) polymerization of monomers (II-A) and subsequent introduction of amine bases (to introduce quaternary ammonium groups) with quaternization of the alkyl chains and release of the leaving groups Y; or
(B) polymerization of quaternized monomers (II-B) and/or
(C) polymerization of monomers (II-A) and quaternized monomers (II-B) and subsequent introduction of amine bases (to introduce quaternary ammonium groups) with quaternization of the alkyl chains and release of the leaving groups Y from the monomer units (II-A).

The process further preferably comprises copolymerization with comonomers as defined herein.

In the process according to the invention, the amine bases for introducing the quaternary ammonium groups are preferably selected from those as defined herein, as well as mixtures thereof.

### IV. Process for the Production of AEM Polymer Membranes

As described, the quaternized polymers/copolymers can be used per se as AEM membranes in the case of hydrophobic comonomers.

To produce the AEM described herein in the form of blend membranes, the polymers/copolymers according to the invention are mixed (blended) with one or more of the inert matrix polymers described above. In principle, this can be done by known methods for blending such polymers, for example also as described in DE102016007815A1. For example, the polymer and/or copolymer according to the invention described herein is dissolved in a solvent, for example selected from DMF, DMAc, DMSO, NMP, to produce a 10-40% by weight solution. Mixing with the matrix polymer is carried out by adding a 2-10% by weight solution of the matrix polymer in a solvent, for example selected from DMF, DMAc, DMSO, NMP, to the solution of the polymers and/or copolymers according to the invention. After homogenization of the mixture of the two solutions, it is transferred to a membrane (film, layer or the like), for example by applying the mixture of the solutions to a suitable surface or a support, such as a glass plate, over a large area, for example by doctoring, and evaporating the solvent, for example in a convection oven, depending on the solvent, for example at temperatures between 80-140° C.

Thus, the process according to the invention for producing hydrophobic (AEM) polymer membranes as described herein comprises in particular
(A) copolymerization of monomers (II-A) and/or (II-B) as described herein with hydrophobic comonomers (as described herein);
(B) blending the polymers and/or copolymers (I) according to the invention with at least one chemically inert matrix polymer, in particular those as defined herein or mixtures thereof; or
(C) blending the mixed precursor polymers and/or copolymers (as described herein) with at least one chemically inert matrix polymer, in particular those as defined herein or mixtures thereof, and with at least one cation exchange polymer and subsequent introduction of amine bases (to introduce quaternary ammonium groups) with quaternization of the alkyl chains and release of the leaving groups Y from the monomer units (II-A).

The cation exchange polymers used in alternative (C) are polymers with a weakly acidic cation exchange group such as the carboxyl group —COOH, a moderately to strongly acidic cation exchanger group such as the phosphonic acid group —PO₃H₂ or the sulfinic acid group —SO₂H, or a strongly acidic cation exchanger group such as the sulfonic acid group —SO₃H or the group —SO₂—NH—SO₂—R (with R=perfluoroalkyl group such as CF₃, C₂F₅, or pentafluorophenyl C₆F₅) attached to any organopolymer backbone, preferably those selected from the group comprising sulfonated and/or phosphonated polymers with a perfluoroalkyl main chain or a non-fluorinated or a partially fluorinated aromatic polymer main chain (polyaryl ethers, polyaryl thioethers, polyaryl ether ketones, polyaryl ether sulfones, polyaryl sulfones, polyaryl ether phosphine oxides, polyaryl phosphine oxides. These are thus basically materials which, in contrast to the polymers according to the invention (anion exchange polymers), have a negative charge. Examples include materials such as Nafion™, phosphonated poly(pentafluorostyrene) (PWN) or other polymers that have been functionalized with the above-mentioned groups.

### V. Styrene Monomers

To the extent that the monomers obtainable by the methods described herein are novel, they are also included within the scope of the invention.

In particular, the invention thus comprises styrene monomers having an alkyl chain functionalized with a leaving group Y according to the following formula (II-A)

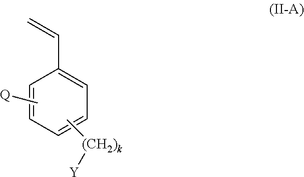

wherein
k=3 to 20;
Q=0-3 same or different substituents from the group of alkyl, alkenyl, heterocyclyl, aryl, heteroaryl, alkoxy, aryloxy, heteroaryloxy, nitro, nitroso and halogen; and
Y=represent a leaving group,
where monomers of the formula (II-A) where k=6 and Y═Br are excluded.

A bromine leaving group has a different reactivity compared to a chlorine leaving group. The preferred alkyl chlorides according to the invention turned out to be surprisingly advantageous, since when alkyl bromides are used in the radical polymerization reaction according to the invention, the radicals present can react with the alkyl bromides, which leads to undesirable crosslinking reactions, rendering the resulting crosslinked polymers unusable. This could be avoided by using the preferred alkyl chlorides.

Particularly preferred are styrene monomers (II-A) in which k is ≥4, preferably >4, more preferably >5, even more preferably ≥6.

Also preferred are in particular such styrene monomers (II-A) in which Y is a leaving group selected from halogens such as F, Cl, Br, I, or mesylate, triflate, tosylate, fluorosulfonates, nitrates, phosphates, nonaflates.

Y is particularly preferably selected from Cl, Br, and I, even more preferably from Cl and Br.

A particularly preferred styrene monomer (II-A) according to the invention is 1-(6-chlorohexyl)-4-vinylbenzene

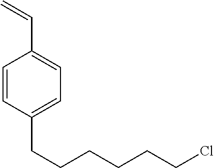

The invention further comprises quaternized styrene monomers according to the following formula (II-B)

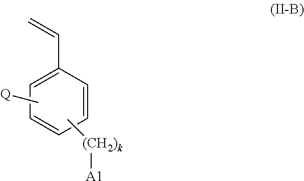

wherein
k=3 to 20;
Q=0-3 identical or different substituents from the group of alkyl, alkenyl, heterocyclyl, aryl, heteroaryl, alkoxy, aryloxy, heteroaryloxy, nitro, nitroso and halogen; and A1=an amine base (comprising a quaternary ammonium group [NR₃⁺] where R=the same or different substituents selected from the group of hydrogen, alkyl, alkenyl, heterocyclyl, aryl and heteroaryl, each as defined above).

Particularly preferred are styrene monomers (II-B) in which k is ≥4, preferably >4, more preferably >5, even more preferably ≥6.

Preferred are in particular also such styrene monomers (II-B) wherein the amine base/quaternary ammonium group NR₃⁺ is selected from the group as defined herein and in particular as shown above under “Amine bases—quaternary ammonium groups NR₃⁺”.

A particularly preferred quaternized styrene monomer (II-B) according to the invention is

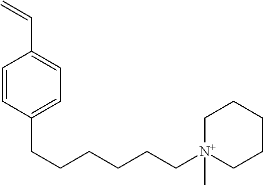 [SMILES: C=Cc1ccc(CCCCCC[N+]2(C)CCCCC2)cc1]

VI. Precursor Polymers or Copolymers with Y-Functionalized Alkane Styrene Monomer Units

To the extent that the precursor polymers obtainable by the methods described herein are novel, they are also included within the scope of the invention.

In particular, the invention comprises precursor polymers having an alkyl chain functionalized with a leaving group Y according to the following formula (III)

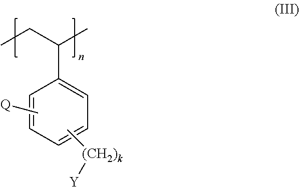

wherein
k=3 to 20;
Q=0-3 same or different substituents from the group of alkyl, alkenyl, heterocyclyl, aryl, heteroaryl, alkoxy, aryloxy, heteroaryloxy, nitro, nitroso and halogen; and
Y=a leaving group,
and where n denotes the degree of polymerization.

Preferred are in particular such precursor polymers (III) wherein k is ≥4, preferably >4, more preferably >5, even more preferably ≥6.

Preferred are in particular also such precursor polymers (III) wherein the leaving group Y is selected from halogen (F, Cl, Br, I), mesylate, triflate, tosylate, fluorosulfonates, nitrates, phosphates, nonaflates; more preferably from Cl, Br, and I, still more preferably Cl and Br.

Preferred are in particular also such precursor polymers (III) which also contain the same or different comonomers selected from the group of styrene-based comonomers and/or from the group of vinyl monomers, preferably styrene-based comonomers are selected from the group comprising styrene, para-alkylstyrenes, 4-vinylbiphenyl, fluorinated styrene, such as mono-, di-, tri-, tetra- and pentafluorostyrene (of which pentafluorostyrene is preferred), and norbornene.

More preferably, styrene-based comonomers and comonomers from the group of vinyl monomers selected from those defined herein are used.

Particularly preferred styrene-based comonomers are selected from styrene and para-alkylstyrenes and 4-vinylbiphenyl.

Particularly preferred comonomers from the group of vinyl monomers are selected from vinylimidazole and 9-vinylcarbazole.

Precursor polymers (III) according to the invention can be linear or branched.

Precursor polymers (III) according to the invention can be random, alternating or block (co-) polymers.

The precursor polymers (III) according to the invention may carry further functional groups, such as those selected from the group comprising alkyl, alkenyl, heterocyclyl, aryl, heteroaryl, alkoxy, aryloxy, heteroaryloxy, nitro, nitroso and halogen (each as defined above) and bis(cyclopentadienyl) metal complexes.

The precursor polymers (III) according to the invention can also be additionally chemically crosslinked. For example, by diamines such as 1,4-diazabicyclo[2.2.2]octane, N,N,N′,N′-tetramethyl-1,6-hexanediamine, N,N,N′,N′-tetramethyl-1,4-butanediamine, N,N,N′,N′-tetramethyl-1,3-propanediamine, bis-[2-(N,N-dimethylamino)-ethyl]-ether.

A particularly preferred precursor polymer (III) according to the invention is

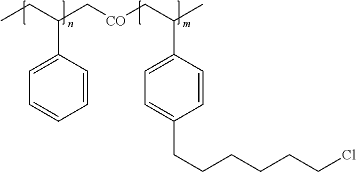

where m and n denote the degree of polymerization and may be the same or different.
VI. Mixed Precursor Polymers or Copolymers with Y-Functionalized Alkane Styrene Monomer Units and Quaternized Alkane Styrene Monomer Units

As described, such polymers/copolymers can also be prepared by the processes according to the invention, wherein a part of the introduced alkyl spacers [—(CH₂)ₖ-] is quaternized, while another part of the introduced alkyl spacers [—(CH₂)ₖ-] carries a leaving group Y. Such so-called mixed precursor polymers or precursor copolymers thus contain both alkane styrene monomer units of the formula (III) shown above

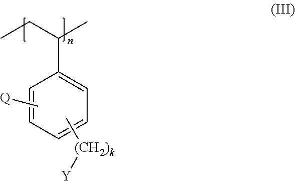

as well as quaternized alkane styrene monomer units of formula (I),

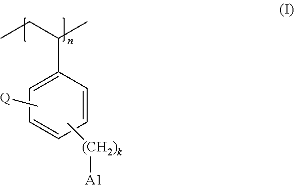

wherein in each of the monomer units (I) and (III) independently of one another
k can be=3 to 20,
Q represents 0-3 same or different substituents from the group of alkyl, alkenyl, heterocyclyl, aryl, heteroaryl, alkoxy, aryloxy, heteroaryloxy, nitro, nitroso and halogen;
Y represents a leaving group, and
A1 represents an amine base (comprising a quaternary ammonium group [NR₃⁺] with R=the same or different substituents from the group of hydrogen, alkyl, alkenyl, heterocyclyl, aryl and heteroaryl)
(all as defined herein) and wherein
n denotes the degree of polymerization;
wherein in such mixed polymers or copolymers the number n of monomer units (I) and the number n of monomer units (III) may be the same or different.

Particularly preferred are such mixed precursor polymers/copolymers wherein k is ≥4, preferably >4, more preferably >5, even more preferably ≥6.

Preferred are in particular also such mixed precursor polymers/copolymers wherein the leaving group Y is selected from halogen (F, Cl, Br, I), mesylate, triflate, tosylate, fluorosulfonates, nitrates, phosphates, nonaflates; more preferably from Cl, Br, and I, still preferred Cl and Br.

Preferred are in particular also such mixed precursor polymers/copolymers wherein the amine base/quaternary ammonium group NR₃⁺ is selected from the group as defined herein and in particular as shown above under “Amine bases—quaternary ammonium groups NR₃⁺”.

Particularly preferred are also such mixed precursor polymers/copolymers which also contain the same or different comonomers selected from the group of styrene-based comonomers and/or from the group of vinyl monomers, preferably styrene-based comonomers are selected from the group comprising styrene, para-alkylstyrenes, 4-vinylbiphenyl, fluorinated styrene, such as mono-, di-, tri-, tetra- and pentafluorostyrene (of which pentafluorostyrene is preferred), norbomenes and side-chain vinylferrocenes.

More preferably, styrene-based comonomers and comonomers from the group of vinyl monomers are selected from those defined herein.

Particularly preferred styrene-based comonomers are selected from styrene and para-alkylstyrenes, as well as 4-vinylbiphenyl.

Particularly preferred comonomers from the group of vinyl monomers are selected from vinylimidazole and 9-vinylcarbazole.

Mixed precursor polymers/copolymers according to the invention can be linear or branched.

Mixed precursor polymers/copolymers according to the invention can be random, alternating or block (co-)polymers.

The mixed precursor polymers/copolymers according to the invention may carry further functional groups, such as those selected from the group comprising alkyl, alkenyl, heterocyclyl, aryl, heteroaryl, alkoxy, aryloxy, heteroaryloxy, nitro, nitroso and halogen (each as defined above) and bis(cyclopentadienyl) metal complexes.

The mixed precursor polymers/copolymers according to the invention can also be additionally chemically crosslinked. For example, by diamines such as 1,4-diazabicyclo[2.2.2]octane, N,N,N′,N′-tetramethyl-1,6-hexanediamine, N,N,N′,N′-tetramethyl-1,4-butanediamine, N,N,N′,N′-tetramethyl-1,3-propanediamine, bis-[2-(N,N-dimethylamino)-ethyl]-ether.

### VIII. Use of the Polymers or Copolymers and Membranes According to the Invention

As described, such polymers/copolymers can also be prepared by the processes according to the invention, wherein a part of the introduced alkyl spacers [—(CH₂)ₖ-] is quaternized, while another part of the introduced alkyl spacers [—(CH₂)ₖ-] carries a leaving group Y. Such so-called mixed precursor polymers or precursor copolymers thus contain both alkane styrene monomer units of the formula (III) shown above

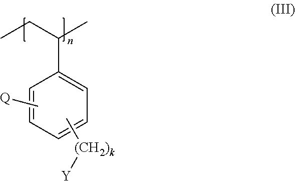

as well as quaternized alkane styrene monomer units of formula (I),

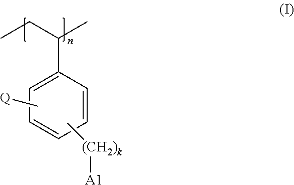

wherein in each of the monomer units (I) and (III) independently of one another
k can be=3 to 20,
Q represents 0-3 same or different substituents from the group of alkyl, alkenyl, heterocyclyl, aryl, heteroaryl, alkoxy, aryloxy, heteroaryloxy, nitro, nitroso and halogen;
Y represents a leaving group, and A1 represents an amine base (comprising a quaternary ammonium group [NR₃⁺] with R=the same or different substituents from the group of hydrogen, alkyl, alkenyl, heterocyclyl, aryl and heteroaryl)
(all as defined herein) and wherein
n denotes the degree of polymerization;
wherein in such mixed polymers or copolymers the number n of monomer units (I) and the number n of monomer units (III) may be the same or different.

Particularly preferred are such mixed precursor polymers/copolymers wherein k is ≥4, preferably >4, more preferably >5, even more preferably ≥6.

Preferred are in particular also such mixed precursor polymers/copolymers wherein the leaving group Y is selected from halogen (F, Cl, Br, I), mesylate, triflate, tosylate, fluorosulfonates, nitrates, phosphates, nonaflates; more preferably from Cl, Br, and I, still preferred Cl and Br.

Preferred are in particular also such mixed precursor polymers/copolymers wherein the amine base/quaternary ammonium group NR₃⁺ is selected from the group as defined herein and in particular as shown above under “Amine bases—quaternary ammonium groups NR₃⁺”.

Particularly preferred are also such mixed precursor polymers/copolymers which also contain the same or different comonomers selected from the group of styrene-based comonomers and/or from the group of vinyl monomers, preferably styrene-based comonomers are selected from the group comprising styrene, para-alkylstyrenes, 4-vinylbiphenyl, fluorinated styrene, such as mono-, di-, tri-, tetra- and pentafluorostyrene (of which pentafluorostyrene is preferred), norbomenes and side-chain vinylferrocenes.

More preferably, styrene-based comonomers and comonomers from the group of vinyl monomers are selected from those defined herein.

Particularly preferred styrene-based comonomers are selected from styrene and para-alkylstyrenes, as well as 4-vinylbiphenyl.

Particularly preferred comonomers from the group of vinyl monomers are selected from vinylimidazole and 9-vinylcarbazole.

Mixed precursor polymers/copolymers according to the invention can be linear or branched.

Mixed precursor polymers/copolymers according to the invention can be random, alternating or block (co-)polymers.

The mixed precursor polymers/copolymers according to the invention may carry further functional groups, such as those selected from the group comprising alkyl, alkenyl, heterocyclyl, aryl, heteroaryl, alkoxy, aryloxy, heteroaryloxy, nitro, nitroso and halogen (each as defined above) and bis(cyclopentadienyl) metal complexes.

The mixed precursor polymers/copolymers according to the invention can also be additionally chemically crosslinked. For example, by diamines such as 1,4-diazabicyclo[2.2.2]octane, N,N,N′,N′-tetramethyl-1,6-hexanediamine, N,N,N′,N′-tetramethyl-1,4-butanediamine, N,N,N′,N′-tetramethyl-1,3-propanediamine, bis-[2-(N,N-dimethylamino)-ethyl]-ether.

### VIII. Use of the Polymers or Copolymers and Membranes According to the Invention

Due to their advantageous properties, as described in detail above, the quaternized polymers/copolymers (I) according to the invention and the water-insoluble polymer membranes (AEM) described herein, in particular the blend membranes according to the invention described herein, are particularly suitable as alkaline (anion exchange) membranes or anion-conducting membranes. This also makes it possible to use them as a binder material for the production of electrodes or as a solid electrolyte, in particular in electrolysis processes, electrodialysis processes, diffusion dialysis processes, such as in particular electrodiffusion dialysis, Donnan dialysis and water electrolysis processes.

In addition, the quaternized polymers/copolymers (I) according to the invention and the hydrophobic polymer membranes (AEM) described herein, in particular the blend membranes according to the invention described herein, are particularly suitable for use in fuel cells or in (redox) flow batteries.

The use of the quaternized polymers/copolymers (I) according to the invention and the water-insoluble polymer membranes (AEM) described herein, in particular the blend membranes according to the invention described herein, as binder material for the production of electrodes or catalyst layers, and as ionomer is also possible and encompassed by the invention.

A further aspect of the invention thus also relates to electrodes, catalyst layer materials, fuel cells or flow batteries containing the quaternized polymers or copolymers (I) or the water-insoluble polymer membranes (AEM) described herein, such as the blend membranes according to the invention.

### DETAILED DESCRIPTION OF THE FIGURES

FIG. 1 ¹H-NMR spectrum in CDCl₃ of 1-(6-chlorohexyl)-4-vinylbenzene (monomer according to the invention (II-A)).

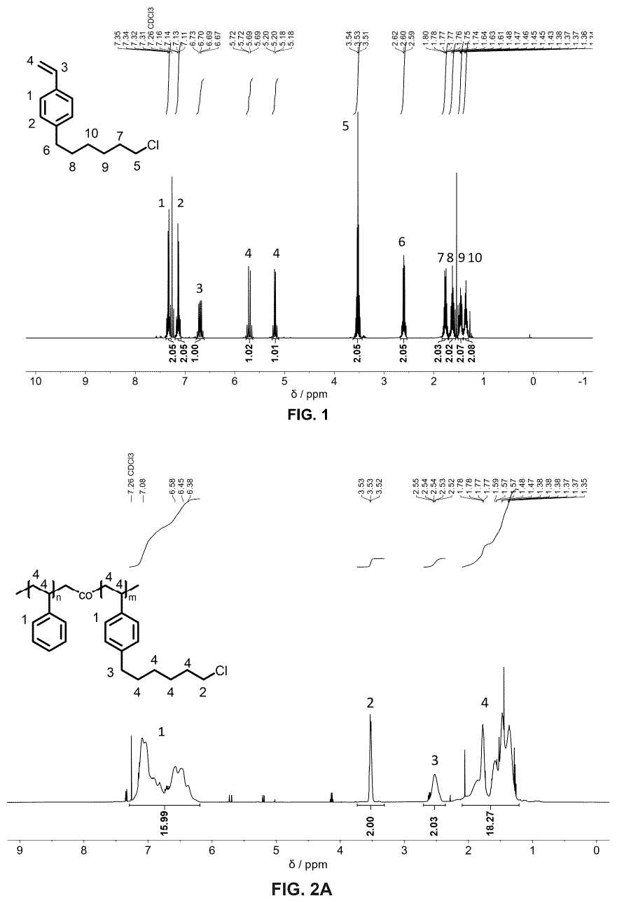

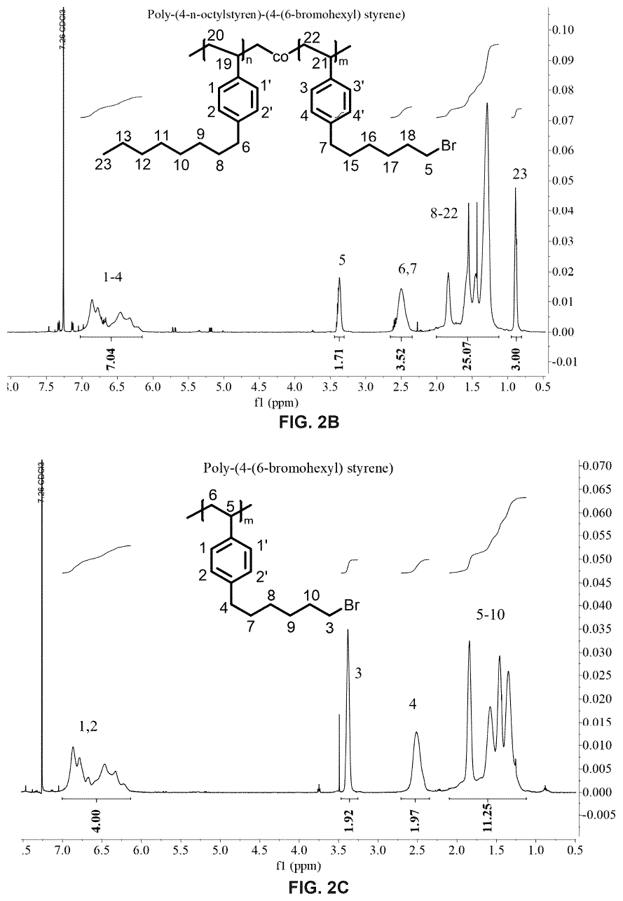

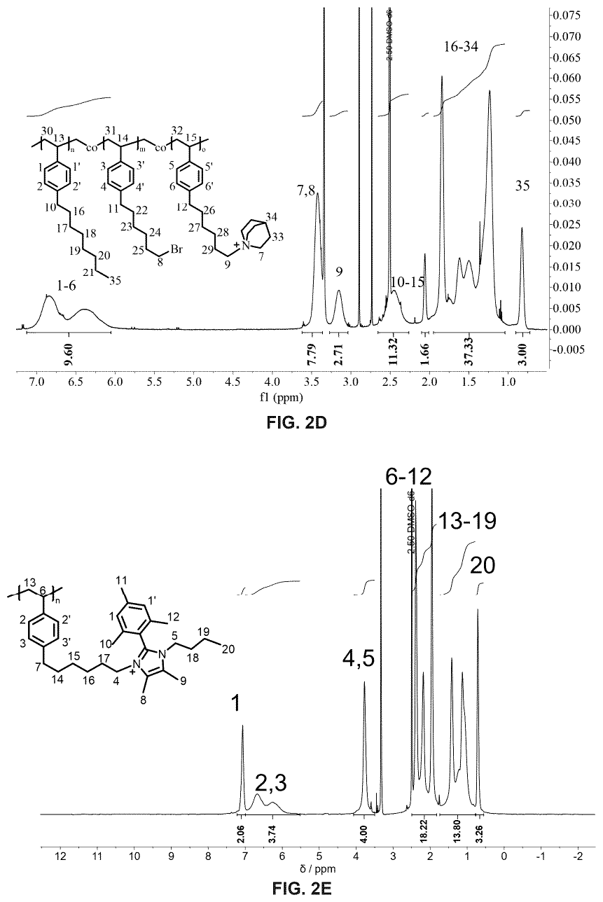

FIG. 2A ¹H-NMR spectrum in CDCl₃ of a copolymer of 1-(6-chlorohexyl)-4-vinylbenzene and styrene (precursor polymer (III) according to the invention) with a proportion of 1-(6-chlorohexyl)-4-vinylbenzene of 30 mol % in the feed.

FIG. 2B ¹H NMR spectrum of a copolymer of 1-(6-bromohexyl)-4-vinylbenzene and 4-n-octylsytrene (poly(4-n-octylstyrene)-co-(4-(6-bromohexyl)styrene).

FIG. 2C ¹H NMR spectrum of a homopolymer of 1-(6-bromohexyl)-4-vinylbenzene (poly(4-(6-bromohexyl)styrene).

FIG. 2D ¹H NMR spectrum of a partially quaternized copolymer poly(4-n-octylstyrene)-co-(4-(6-bromohexyl)styrene.

FIG. 2E ¹H NMR spectrum of a poly(4-(6-bromohexyl)styrene quaternized with 1-butyl-2-mesityl-4,5-dimethyl-1H-imidazole.

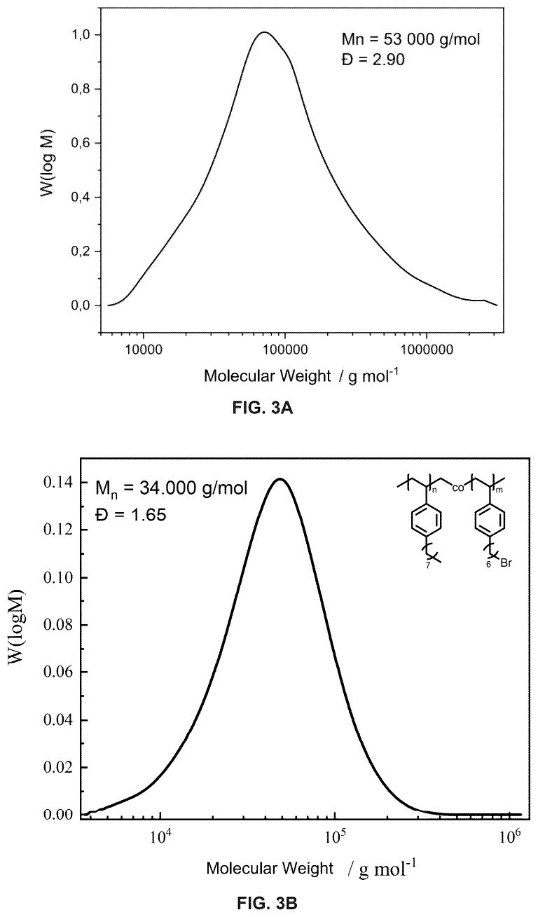

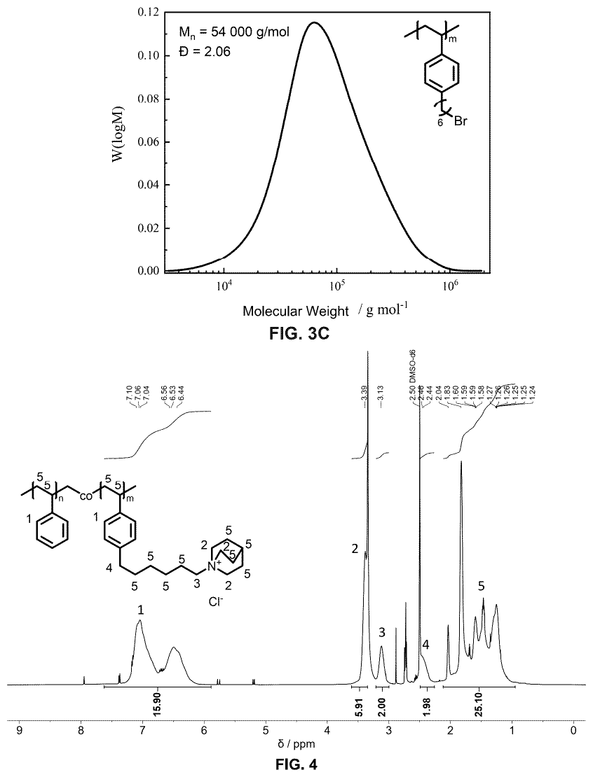

FIG. 3A GPC curve of the copolymer of 1-(6-chlorohexyl)-4-vinylbenzene and styrene measured in THF against polystyrene standard.

FIG. 3B GPC curve of the copolymer poly(4-n-octylstyrene)-co-(4-(6-bromohexyl)styrene measured in THF against narrowly distributed polystyrene standards.

FIG. 3C GPC curve of the homopolymer poly(4-(6-bromohexyl)styrene measured in THF against narrowly distributed polystyrene standards.

FIG. 4 ¹H-NMR spectrum in DMSO-d₆ of a copolymer of 1-(6-chlorohexyl)-4-vinylbenzene and styrene, which was reacted with quinuclidine to give the quaternary amine (quaternized copolymer (I) according to the invention).

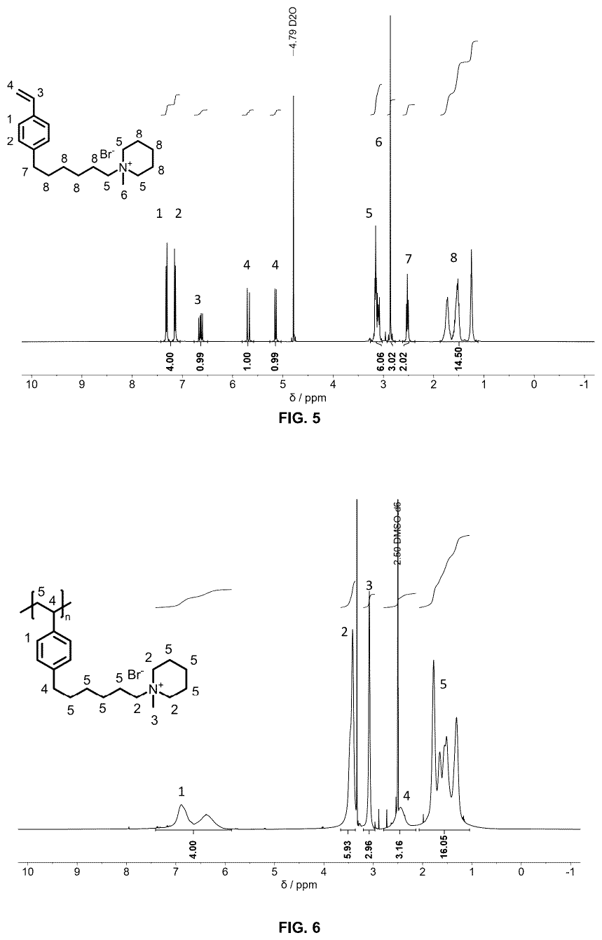

FIG. 5 ¹H-NMR spectrum in DMSO-d₆ of 1-(6-chlorohexyl)-4-vinylbenzene which was quaternized with N-methylpiperidine (quaternized monomer (II-B) according to the invention).

FIG. 6 ¹H-NMR spectrum in DMSO-d₆ of 1-methyl-1-(6-(4-vinylphenyl)hexyl)piperidin-1-ium bromide (quaternized homopolymer (I) according to the invention).

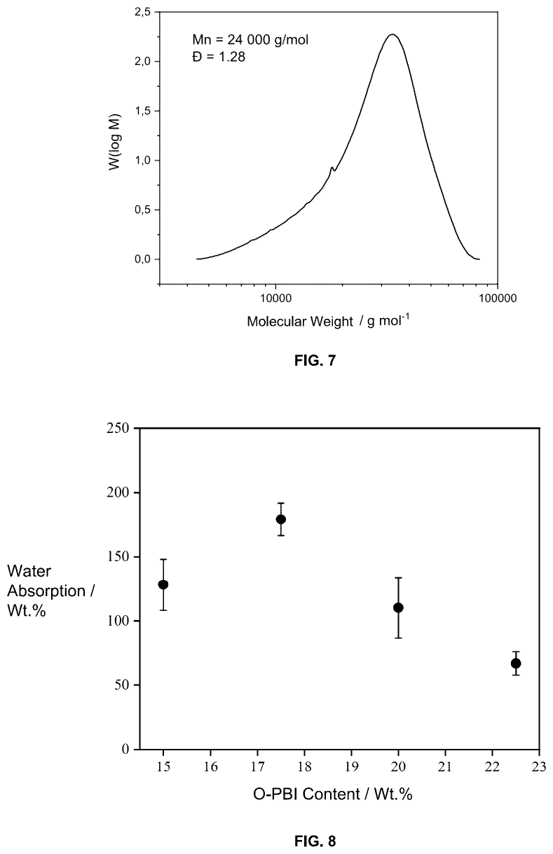

FIG. 7 GPC curve of 1-methyl-1-(6-(4-vinylphenyl)hexyl)piperidine-1-ium bromide (quaternized homopolymer according to the invention (I)) measured in 0.1 M LiCl DMSO against PMMA standards.

FIG. 8 Water absorption of the blend membranes of a polymer quaternized with 1-butyl-2-mesityl-4,5-dimethyl-1H-imidazole as a function of the O-PBI content.

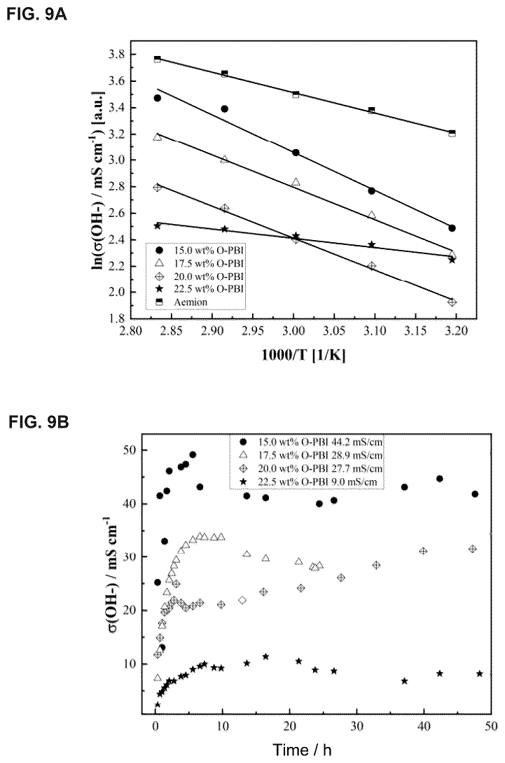

FIG. 9A Arrhenius plot of mixed HCO₃/OH conductivity as a function of inverse temperature at 95% relative humidity under N₂ atmosphere for blend membranes of 1-butyl-2-mesityl-4,5-dimethyl-1H-imidazole quaternized poly(4-(6-bromohexyl)styrene with different O-PBI contents in comparison to Aemion as commercial reference.

FIG. 9B Hydroxide conductivity during a galvanostatic step at 100 μA at 40° C. and 95% relative humidity for blend membranes made of 1-butyl-2-mesityl-4,5-dimethyl-1H-imidazole quaternized poly(4-(6-bromohexyl)styrene with different O-PBI contents.

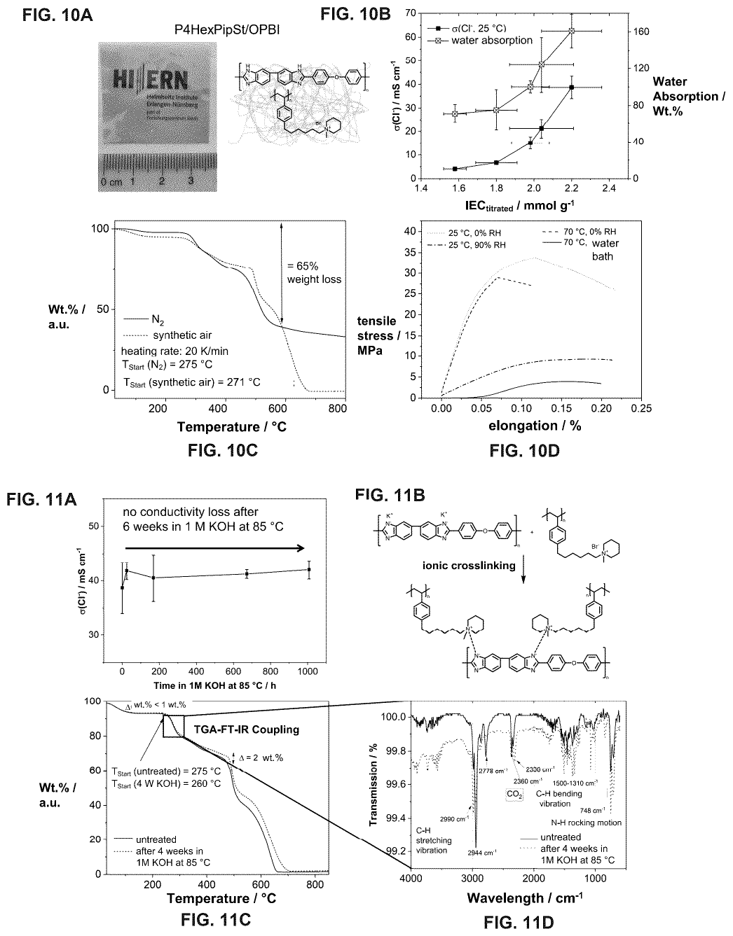

FIG. 10A Image of a homogeneous blend membrane with a thickness of 50 μm and representation of the two blend components.

FIG. 10B Chloride conductivity at room temperature and water absorption at 85° C. as a function of the ion exchange capacity (IEC).

FIG. 10C TGA curve of a blend membrane with a P4HexPipSt content of 65 wt %, which corresponds to an IEC of 1.58 mmol/g.

FIG. 10D Tensile stress curve of a blend membrane with an IEC of 2.20 mmol/g at different humidification conditions (0% RH, 90% RH, fully hydrated) and different temperatures (25° C. and 70° C.).

FIG. 11A Conductivities after treatment of the membranes with 1 M KOH at 85° C. for different time intervals. A blend membrane with an IEC of 2.20 mmol/g was examined.

FIG. 11B The stability of the membrane can also be explained by the formation of ionic crosslinking sites in the alkaline.

FIG. 11C Comparison of the TGA curves of a blend membrane before and after treatment of a blend membrane with 1 M KOH at 85° C. for 4 weeks.

FIG. 11D IR spectra of the gaseous degradation products of the marked area of the TGA curve.

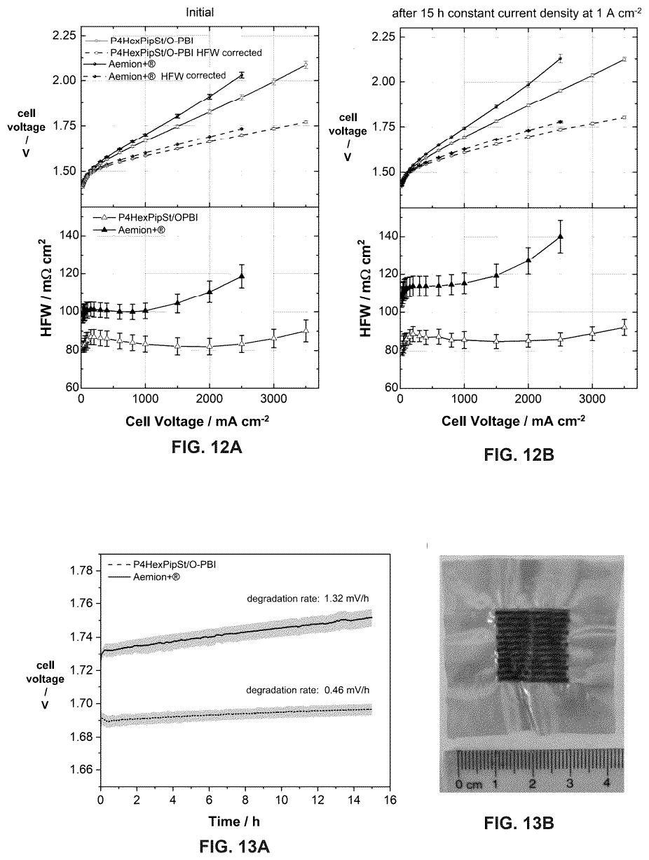

FIG. 12A Polarization curves and high frequency resistance (HFR) of a P4HexPipSt/OPBI blend membrane with an IEC of 2.20 mmol/g compared to Aemion+® AF3-HWK9-75-X 75 as a commercially available reference. Measurements were performed at 70° C. in 1 M KOH.

FIG. 12B Polarization curves after holding the current at 1 A/cm² for 15 h.

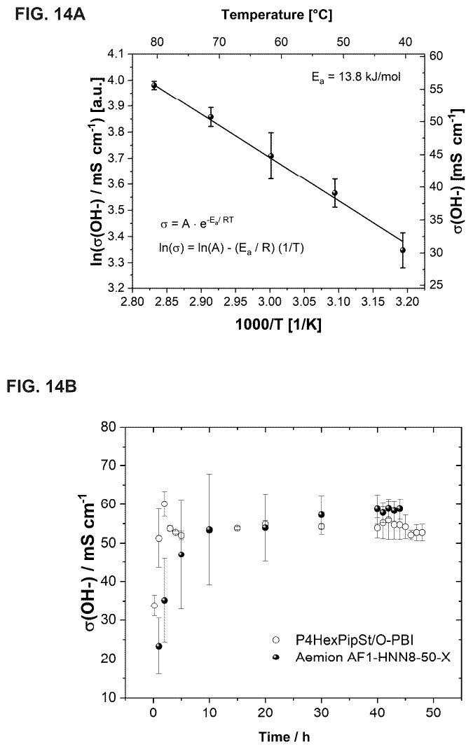

FIG. 13A Cell voltage during the galvanostatic step at 1 A/cm² for P4HexPipSt/OPBI (IEC=2.20 mmol/g) and Aemion+®.

FIG. 13B The blend membrane after the cell experiment shows no optical changes, only residues of the catalyst on the membrane surface are visible.

FIG. 14A Arrhenius plot of the mixed HCO₃/OH conductivity as a function of inverse temperature at 95% relative humidity under N₂ atmosphere.

FIG. 14B Hydroxide conductivity during a galvanostatic step at 100 μA at 40° C. and 95% relative humidity.

### EXAMPLES

### 1a. Preparation of Monomers According to the Invention According to Process Step 1/Preparation of 1-(6-Chlorohexyl)-4-Vinylbenzene

The Y-functionalized monomer (II-A) can be prepared by a cuprate-catalyzed reaction of a styrylgrignard reagent with a dihaloalkane such as 1,6-dibromohexane, where the dihaloalkane is used in quadruple excess to suppress double functionalization (V Bertini et al., Monomers containing substrate or inhibitor residues for copper amine oxidases and their hydrophilic beaded resins designed for enzyme interaction studies, Tetrahedron, 2004, 60, 11407-11414; S. Alfei et al, Synthesis, Characterization, and Bactericidal Activity of a 4-Ammoniumbuthylstyrene-Based Random Copolymer, Polymers, 2021, 13. DOI 10.3390/polym13071140).

The preparation of the monomers (II-A) according to the invention is described herein using 1-(6-chlorohexyl)-4-vinylbenzene as an example.

The styrylgrignard can be prepared, for example, by reacting 4-chlorostyrene (27.718 g, 200.0 mmol, 1,000 equivalents) with elemental magnesium (5.154 g, 212.0 mmol, 1,060 equivalents) in refluxing THF. For this purpose, the 4-chlorostyrene is dissolved in dry THF (266.7 mL) and slowly dripped into a dropping funnel to the magnesium suspended in dry THF (26.7 mL). Initially, only 5% by volume of the 4-chlorostyrene solution is added. Then heat the resulting mixture of magnesium, THF and 4-chlorostyrene to 64° C. and wait for the reaction to start (formation of bubbles, discoloration of the reaction solution to brown). The remaining 4-chlorostyrene solution is then added slowly over 1 hour. The reaction mixture is then heated for a further 2 h and refluxed. The Grignard solution is then slowly dripped into a solution of 1-bromo-6-chlorohexane (399.0 g, 2.000 mol, 10.00 equivalents) cooled to 0° C. in THF. The 1-bromo-6-chlorohexane solution was previously mixed with 24.60 mL of a 0.5-molar LiCuBr₂ solution. The LiCuBr₂ solution was prepared by dissolving LiBr (2.606 g, 30.00 mmol) and CuBr (2.152 g, 15.00 mmol) in dry THF (30 mL). The cuprate catalyst is deactivated and masked by the addition of 500 mL of a 0.65 M aqueous NaCN/NH₄Cl (4:25 wt %) solution. The crude product is extracted with 3 times 500 mL diethyl ether, the organic phase is dried over magnesium sulfate and the solvents are removed on a rotary evaporator. The isolation of the target substance (II-A), in this case 1-(6-chlorohexyl)-4-vinylbenzene, is carried out in two successive purification steps. First, the excess 1-bromo-6-chlorohexane is removed by vacuum distillation (p<0.001 mbar, T_{heating}=70° C., Tᵥₐₚₒᵣ=55° C.). The crude product is then purified by column chromatography and/or vacuum distillation (p<0.001 mbar, T_{heating}=120° C., Tᵥₐₚₒᵣ=81-91° C.) to obtain analytically pure monomers (II-A), in this case 1-(6-chlorohexyl)-4-vinylbenzene.

Surprisingly, it was found that when a mixed halogenoalkane such as 1-bromo-6-chlorohexane is used, almost exclusively the bromine atom is substituted and thus the corresponding 1-(6-chlorohexyl)-4-vinylbenzene is readily accessible synthetically. FIG. 1 shows the ¹H-NMR spectrum of 1-(6-chlorohexyl)-4-vinylbenzene after the purification described above.

As already described above, it was surprisingly found that the chlorine substituent offers the advantage over a bromine substituent that chloroalkanes, in contrast to bromoalkanes, are less prone to chain transfer reactions in radical polymerizations, which in turn enables the synthesis of non-crosslinked and thus soluble polymers.

### 1b. Preparation of Monomers According to the Invention According to Process Step 1/Preparation of 1-(6-Bromohexyl)-4-Vinylbenzene

The synthesis conditions for the preparation of the monomer 1-(6-bromohexyl)-4-vinylbenzene were applied analogously to the example embodiment for the preparation of 4-(6-chlorohexyl)styrene.

### 2a. Preparation of Polymers/Copolymers According to the Invention

The conversion of the monomers according to the invention (II-A) and/or (II-B) to polymers according to the process variants a), b) or c) described above is carried out by free radical or controlled (ATRP, RAFT, NMP) radical polymerization. For this purpose, the monomers are dissolved in a suitable solvent (e.g. toluene, DMF or THF) and 0.01-1 mol % of a radical initiator such as azobisisobutyronitrile is added.

The copolymerization of 1-(6-chlorohexyl)-4-vinylbenzene is carried out analogously to the processes described above with a suitable comonomer as described here using styrene as the comonomer:

The preparation of the material shown in FIG. 2a is described below as an example. 1-(6-Chlorohexyl)-4-vinylbenzene (0.928 g, 4.166 mmol, 0.434 equivalents) and styrene (1.000 g, 1.100 mL, 9.602 mmol, 1.000 equivalents) are dissolved in chlorobenzene (1.503 mL). Azobis(isobutyronitrile) (0.019 g, 0.116 mmol, 0.056 equivalents) is then added. Oxygen contained in the solution prepared in this way is removed by freezing the reaction vessel under an argon atmosphere with liquid nitrogen and evacuating the frozen reaction solution using a rotary vane pump. After thawing the evacuated reaction vessel, it is frozen again and evacuated once more. These degassing steps are carried out at least 3 times. After the last degassing step, the reaction vessel is sealed under an argon atmosphere and stirred at 65° C. for 24 hours. The polymer is isolated by slowly pouring the mixture into 50 mL methanol and separating the precipitated polymer from the precipitant by filtration. After a drying step at 60° C. in a vacuum, the precursor polymer can be used for the quaternization step.

The Y-alkyl-substituted precursor polymer (III) obtained in this way is shown in FIG. 2a with its GPC curve according to FIG. 3a. In addition to the radical initiator, the monomer according to the invention and the solvent, styrene is added as a comonomer (in principle, it is also possible to add other comonomers as described herein). The other copolymerization parameters can be selected analogously to the polymerization procedure described above.

Surprisingly, it was found that in the free radical copolymerization of 1-(6-chlorohexyl)-4-vinylbenzene with styrene, the incorporation ratio of the two monomers in the polymer corresponds exactly to the proportion in the feed, as shown by the ¹H-NMR spectrum of a copolymer with 30 mol % 1-(6-chlorohexyl)-4-vinylbenzene in the feed (FIG. 2a) with its GPC spectrum (FIG. 3a).

A RAFT polymerization as described above was exemplarily carried out using 2-(dodecylthiocarbonothioylthio)-2-methylpropanoic acid as RAFT agent, wherein the preferred 1-(6-chlorohexyl)-4-vinylbenzene according to the invention was polymerized with styrene as comonomer. Solvent, temperature and time were chosen as indicated above. For the RAFT polymerization, the RAFT agent 2-(dodecylthiocarbonothioylthio)-2-methylpropanoic acid is used in a 5-10 fold molar excess relative to the radical initiator.

A controlled radical polymerization by means of nitroxide-mediated radical polymerization (NMP) was exemplarily carried out with the preferred 1-(6-chlorohexyl)-4-vinylbenzene according to the invention, dibenzoyl peroxide as radical initiator and anisole as solvent. The stabilized radical used was 2,2,6,6-tetramethylpiperidinyloxyl (TEMPO). Polymerization was carried out at temperatures between 8° and 200° C. for 5 to 48 hours. Analogous to RAFT polymerization, the synthesis of block copolymers was carried out by adding styrene as a comonomer (although in principle it is also possible to add other comonomers as described here). After isolation of the first block, the polymerization protocol was repeated with the comonomer styrene.

Quinuclidine was introduced as an amine base for the quaternization of the precursor polymer shown in FIG. 2a in a quaternization reaction at a temperature of 80° C. and a reaction time of 3 days to obtain a copolymer of 1-(6-chlorohexyl)-4-vinylbenzene and styrene quaternized with quinuclidine. For this purpose, the polymer (0.500 g) and quinuclidine (0.412 g) were dissolved in dry THF (7.00 mL) and heated to 80° C. for 3 days. It was found that functionalization levels of almost 100% were possible (see FIG. 4).

The quaternization of the monomers can be carried out analogously, as shown, for example, for the monomer 1-(6-chlorohexyl)-4-vinylbenzene with N-methylpiperidine in ethyl acetate or acetonitrile as solvent, which is preferred according to the invention (see FIG. 5). Specifically, the quaternized monomer shown in FIG. 5 was prepared by reacting (6-bromohexyl)-4-vinylbenzene (5,000 g, 18,712 mmol, 1,000 equivalents) with N-methylpiperidine (3,395 mL, 28,068 mmol, 1,500 equivalents) in ethyl acetate (15.00 mL). The precipitated quaternized monomer was filtered off and washed several times with ethyl acetate to remove impurities.

For the polymerization of the quaternized monomers (step 2, variant a), an adjustment of the polymerization conditions was necessary. For this purpose, the quaternized monomer 1-methyl-1-(6-(4-vinylphenyl)hexyl)piperidine-1-ium bromide (1.200 g, 3.275 mmol) was dissolved in a mixture of DMF/water (1:1, 2:1, 1:2 volume fractions) to produce a 50 wt % solution. Azobisisobutyronitrile (5.00 mg, 0.033 mmol, 0.01 equivalents) was then added as initiator and the mixture was stirred for 48 h at 65° C. The product was isolated by freeze-drying after dialysis against water. The ¹H-NMR spectrum shows all relevant signals that can be assigned to the polymer (see FIG. 6). The successful polymerization is also evident from the GPC curve (see FIG. 7).

### 2b. Preparation of Polymers/Copolymers According to the Invention from Bromo-Substituted Monomers According to the Invention

The 1-(6-bromohexyl)-4-vinylbenzene prepared according to Example 1b was copolymerized with 4-n-octylsytrene to form poly(4-n-octylstyrene)-co-(4-(6-bromohexyl)styrene:

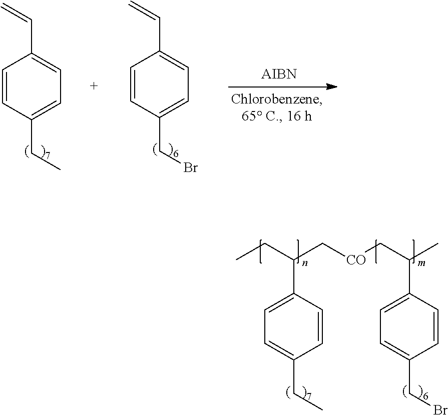

In a second approach, 1-(6-bromohexyl)-4-vinylbenzene was homopolymerized to poly(4-(6-bromohexyl)styrene:

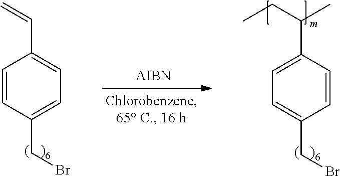

The NMR spectra and structural formulae of the homopolymers and copolymers obtained in this way are shown in FIGS. 2b and 2c.

GPC analyses confirm the formation of the homopolymer and copolymer (FIGS. 3b and 3c).

### 3. Production of AEM Polymer Membranes

The quaternized polymers/copolymers can be used per se as AEM membranes in the case of hydrophobic comonomers. The membranes are produced by preparing a 30% by weight solution of the polymers in DMF, DMAc, NMP or DMSO and doctoring onto a glass plate with subsequent evaporation of the solvent at 110° C. The membrane is detached after immersion in water. The membrane is removed from the glass plate after immersion in water. The resulting membrane has a thickness of 62 μm and a chloride conductivity of 52 mS/cm, determined by electrochemical impedance spectroscopy in 1 M NaCl as electrolyte.

### 3.1 Preparation of Partially Quaternized Copolymers

For example, the copolymers according to example 2b were partially quaternized:

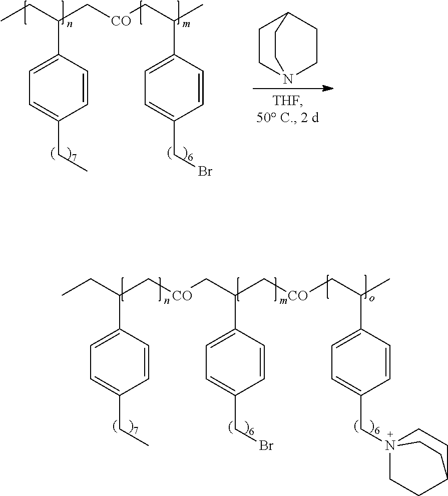

where the remaining bromine sites were crosslinked with N,N,N′,N′-tetramethylethylenediamine to increase the stability of the membrane. FIG. 2d shows the ¹H-NMR spectrum of this partially quaternized copolymer.

Copolymers with a proportion of 1-(6-bromohexyl)-4-vinylbenzene between 30 and 60 mol % were investigated. Furthermore, different degrees of quaternization were investigated in proportion to the amount of 1-(6-bromohexyl)-4-vinylbenzene in the copolymer, whereby between 95 and 70 mol % of the bromine sites were quaternized. The remaining bromine sites were used for the crosslinking reaction. The following table shows the data of the membranes obtained in this way.

| | 4-(6-bromo | | Degree | | |
|---|---|---|---|---|---|
| | hexyl) | 4-n-octyl | of cross- | | |
| | styrene | styrene | linking | | Cl⁻ |
| No. | [%] | [%] | [%] | IEC | conductivity |
| 1 | 50 | 50 | 30 | 1.65 | 32.5 +/− 3.1 |
| 2 | 60 | 40 | 30 | 1.80 | 33.3 +/− 3.3 |

### 3.2 Preparation of Quaternized Homopolymers

The homopolymer, the preparation of which is described in Example 2b, was quaternized with a sterically hindered imidazole, which is known for its high alkali stability:

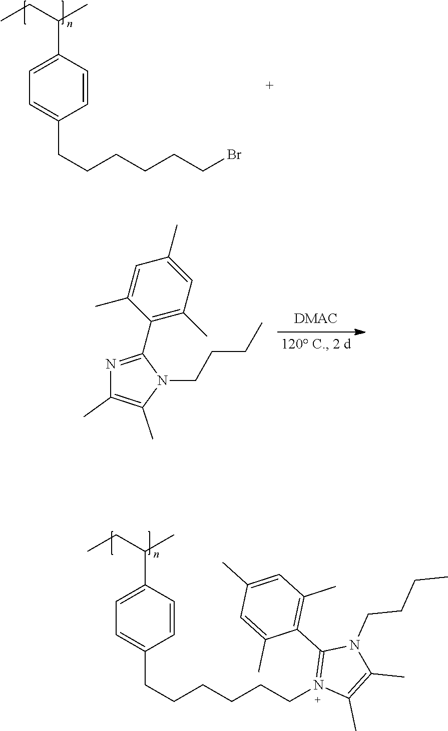

The ¹H-NMR spectrum of this new anion exchange polymer is shown in FIG. 2e. The signal clearly shows the resonance signal of the aromatic protons in the benzyl ring of the introduced imidazole group and the methyl group of the butyl side chain.

### 4. Preparation and Characterization of Blend Membranes According to the Invention

To prepare blend membranes, the polymers/copolymers of the invention are mixed (blended) with inert matrix molecules selected from the polybenzimidazole derivatives shown above, by preparing a 10-50% by weight solution of the polymers/copolymers according to the invention in solvents selected from DMSO, DMF, DMAc or NMP and mixing it with a solution of the polybenzimidazole derivatives shown above in solvents selected from DMSO, DMF, DMAc or NMP.

### 4.1 Preparation and Characterization of Blend Membranes Based on Polymerized 1-Methyl-1-(6-(4-Vinylphenyl)Hexyl)Piperidine-1-Ium Bromide (P4HexPipSt)

The polymer based on 1-methyl-1-(6-(4-vinylphenyl)hexyl)piperidin-1-ium bromide (see FIG. 6) produced according to Example 2a was used to produce a blend membrane according to the invention.

Specifically, 600 mg of the polymer can be obtained by polymerization of 1-methyl-1-(6-(4-vinylphenyl)hexyl)piperidine-1-ium bromide dissolved in 5,288 g of DMSO. After adding 4,300 g of a 5 wt % solution of O-PBI in DMSO, the solution is stirred for 3 h at 80° C. to obtain a homogeneous mixture. After adding a further 1,600 g of DMSO, the blend solution is squeegeed with a squeegee blade at a slit width of 0.950 mm and the solvent is evaporated at 110° C. for 24 hours. The resulting membrane has a thickness of 42 μm and a chloride conductivity of 20 mS/cm, determined by electrochemical impedance spectroscopy in 1 M NaCl as electrolyte.

FIG. 10 shows the characterization of such blend membranes made of P4HexPipSt. As the content of the novel P4HexPipSt in the polymer mixture increases, the water uptake and the conductivity increase at the same time, although the relationship does not appear to be linear (FIG. 10b).

The presence of the positively charged polymer in the polymer mixture is evident from the increasing water absorption and conductivity with the content of the claimed polymer in the polymer mixture. Furthermore, the cationic polymer is recognizable as the first degradation step in the TGA curve (FIG. 10c). The mechanical properties of the blend (FIG. 10d) vary with the ambient conditions, with the modulus of elasticity (Young's modulus) decreasing as the humidity increases. The modulus of elasticity decreases from 617 MPa at 25° C. and 0% relative humidity to 53 MPa at 70° C. and complete hydration (FIG. 10d). This can be explained by the softening effect of the absorbed water, which leads to the membranes becoming significantly more flexible with increasing water content. 4.2 Stability Tests of a Poly-4-(Hexyl-6-(Piperidin-1-ium)-Styrene (P4HexPipSt) Blend Membrane According to the Invention

In addition to the basic physicochemical properties, the stability of the anion exchange membrane in a strongly alkaline medium is also crucial for use in electrochemical membrane processes such as alkaline membrane water electrolysis (AEMWE) or fuel cells (AEMFC).

The stability of the membranes was therefore investigated by immersing them in 1 M KOH at 85° C. for different times. The conductivities were then determined and the TGA curves before and after immersion were compared (FIG. 11a).

It was found that even after 6 weeks in 1 M KOH at 85° C., the membranes showed no loss of conductivity. This observation is supported by the practically congruent TGA curves before and after treatment with 1 M KOH (FIG. 11c). Degradation of the cationic group of P4HexPipSt takes place primarily at temperatures above 300° C. Therefore, congruent TGA curves before and after treatment with KOH show that no chemical degradation of the cationic head group has taken place. Based on the available data, it can therefore be assumed that the novel blend membranes according to the invention are stable for at least 1000 hours. A significantly higher stability can be assumed.

### 4.3 Further Examples for the Preparation and Characterization of Blend Membranes According to the Invention

The polymers obtained according to Example 3.1 and 3.2 were then blended with different proportions of OPBI to obtain mechanically stable blend membranes, which were also investigated with regard to their conductivity.

It was shown that with increasing O-PBI content in the blend membranes, the water absorption decreases, which is accompanied by a simultaneous improvement in the mechanical properties. FIG. 8 illustrates this behavior using the example of a blend membrane based on the polymer according to example 3.2.

At the same time, however, the hydrophobic O-PBI also reduces the ionic conductivity, which makes it necessary to specifically adjust the O-PBI content in order to obtain useful material properties for electrochemical applications (FIG. 9). The conductivity data in FIG. 9 show that the blend membranes with a proportion of 15 wt % O-PBI have the best conductivity.

### 5. Examples of Application

Suitable electrodes for alkaline water electrolysis or alkaline fuel cells and a corresponding test stand are required to test the membranes. For example, the membranes prepared above are tested in an electrolysis cell consisting of a porous gold-coated titanium gas diffusion layer at the anode with IrO₂ as a catalyst for the oxygen evolution reaction (as described above) and a carbon gas diffusion layer with a Pt catalyst supported on carbon for the hydrogen evolution reaction at the cathode. The tests include a measurement of the polarization curve (current-voltage characteristic), the high-frequency resistance and the composition of the evolving gases. A further particular advantage of the AEM fuel cells according to the present invention is that non-precious metal catalysts such as Ni, Co and Fe can also be used in alkaline electrolysis, which means a considerable cost saving.

For the application of the AEMs according to the invention in redox flow batteries, it is necessary that the membranes according to the invention are also stable over the long term in an acidic medium, as is the case in vanadium redox flow batteries, for example, in which the electrolyte has a sulphuric acid concentration of up to 4 molar. In addition, the membranes according to the invention must also be stable under the influence of the very strongly oxidizing or reducing vanadium salt electrolytes of different oxidation states (II, III, IV, V).

### 6. Comparative Examples

### 6.1 Suitability of the Polymers for the Preparation of Blend Membranes

In comparison with the polymers/copolymers and AEMs according to the invention, a polymer with a halomethylated monomer unit (k=1), such as those which are the subject matter of DE102016007815A1, was investigated with regard to its suitability for the production of blend membranes.

A polymer according to Example 2a (see also FIG. 6) was prepared as the reference polymer, in which the alkyl spacer had a chain length of k=1 and thus corresponds to a halomethylated group according to the prior art. This halomethylated group was quaternized as described in Example 2 and the resulting quaternized reference polymer (with a functional group [R₃N—CH₂—]) was blended with O-PBI as a blend polymer as described in Example 3.

It was found that polymers with such a short quaternized alkyl group (k=1) exhibited poor miscibility with the inert matrix polymers (blend polymers). The mixture of the solutions of reference polymer and blend polymer became cloudy, insoluble gel lumps were formed and if these could be converted into a reasonably dissolved state with a great deal of experimental effort (e.g. high temperatures, strong stirring and the effect of strong shear forces, etc.), this only resulted in very brittle and mechanically unstable blend membranes, which disintegrated and crumbled under the slightest mechanical action.

Such short-chain quaternized alkyl-styrene polymers are therefore not suitable for the production of membranes, in particular blend membranes.

### 6.2 Applicability in Alkaline Membrane Water Electrolysis (AEMWE)

In the next step, the applicability of the blend membranes according to the invention in alkaline membrane water electrolysis (AEMWE) was demonstrated. A comparison with a commercially available membrane for this application demonstrated the great potential of the membranes according to the invention.

The results of the electrochemical tests in the AEMWE are shown in FIG. 12. The blend membranes according to the invention outperform the commercial reference Aemion+® AF3-HWK9-75-X 75, particularly in the ohmic range of the polarization curves, which can be explained by the lower high-frequency resistance (HFW) of the blend membranes.

Especially after holding the current at 1 A/cm² for 15 h, it becomes clear that the polarization curves of the blend membranes are practically identical to the initial curve, whereas for Aemion+® a clear increase in the HFW and thus a shift of the polarization curve to a higher voltage could be shown. This becomes clear when looking at the voltage curve during constant current at 1 A/cm² (FIG. 13).

For a blend membrane P4HexPipSt/OPBI according to the invention, the degradation rate under the short galvanostatic step of 0.46 mV/h was significantly lower than for the commercial reference Aemion+®. It is widely known that the degradation rate is highest at the beginning of a cell experiment within the first 150 h and stabilizes with increasing test duration.

In the test setup described here, the same electrodes were used in each case with Aemion+ as the electrode ionomer. It was found that the degradation of the Aemion membrane was higher than that of the membrane according to the invention.

In a further possible application according to the invention, the polymer material according to the invention is introduced into the electrodes as an ionomer.

It is to be expected that thereby the degradation of such an arrangement can be further reduced.

### 7. Determination of Hydroxide and Chloride Conductivity Using Electrochemical Impedance Spectroscopy

The chloride conductivities of the membranes of the sample polymers listed above in the fully hydrated state were measured with a Zahner Elektrik IM6, using aqueous 1 M NaCl as electrolyte. The membranes were placed between two commercial Aemion (AF1-HNN8-50-X) membrane pieces. Subsequently, the impedance of the layer of the two Aemion (AF1-HNN8-50-X) membrane pieces was measured with the membranes of the present invention and the impedance of only the two Aemion (AF1-HNN8-50-X) membranes was measured without the membrane under investigation. The difference between the two impedances then gave the impedance of the membrane under investigation. Two identical gold electrodes with an electrode area of 0.25 cm² were used as electrodes. The impedance was measured in a range from 200 kHZ to 8 MHz and then the conductivity a of the membrane under investigation was calculated using the following formula, where Rₛₚ is the specific resistance resulting from the measured resistance divided by

$${R}_{sp} = \frac{R \cdot A}{d} .$$

Furthermore, A indicates the electrode area (here 0.25 cm²) and d the thickness of the membrane:

$$σ = \frac{1}{{R}_{sp}} = \frac{d}{R \cdot A}$$

In this way, the conductivities given in Example 3 (Preparation of AEM polymer membranes) were determined. The hydroxide conductivity was measured using a Scribner MTS 740 membrane test system in an N₂ atmosphere, whereby the membranes were converted to the hydroxide form by immersion in KOH prior to measurement.

Since membranes with hydroxide counterions react with the CO₂ in the ambient air to form HCO₃, a special procedure is required to measure the pure hydroxide conductivity in order to ensure that the membrane is in the pure hydroxide form. For this purpose, the hydroxide ions are electrochemically generated in situ by a galvanostatic step at 100 μA and HCO₃⁻ reacts to gaseous CO₂, which is released into the ambient air. The measurements are carried out under pure N₂ to ensure that the reverse reaction does not occur.

In the mixed HCO₃⁻/OH⁻ form, the conductivity shows Arrhenius behavior as a function of temperature (FIG. 14a), which is typical for anion exchange membranes. The conductivity initially rises sharply during the galvanostatic step at 100 μA and then stabilizes at a value of 55 mS/cm after approx. 30 h (FIG. 14a). This corresponds to almost twice the initial value. The determined hydroxide conductivity at the end of the galvanostatic step is similar to the commercial reference Aemion AF1-HNN8-50-X (FIG. 14b).

### 8. Conclusion

The above tests have shown that the polymers, copolymers and blend membranes according to the invention could be successfully produced and exhibit improved properties compared to commercial materials in characterization and application tests. In addition, the suitability of the materials described herein in the applications according to the invention was demonstrated.

1. Water-insoluble polymer membrane (AEM) comprising a polymer or copolymer containing quaternized alkane styrene monomer units of the following formula (I), 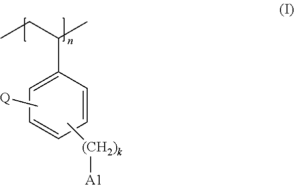
wherein
k=3 to 20;
Q=0-3 same or different substituents selected from the group consisting of alkyl, alkenyl, heterocyclyl, aryl, heteroaryl, alkoxy, aryloxy, heteroaryloxy, nitro, nitroso, halogen, and combinations thereof;
A1=an amine base selected from the group consisting of 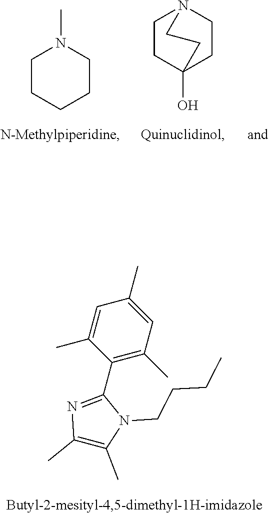
wherein the bond to the —(CH₂)ₖ spacer of the alkane styrene monomer unit (I) takes place via a nitrogen atom to form a quaternary ammonium group;
and wherein n denotes the degree of polymerization,
which further comprises at least one chemically inert matrix polymer, wherein chemically inert matrix polymers are selected from the group consisting of 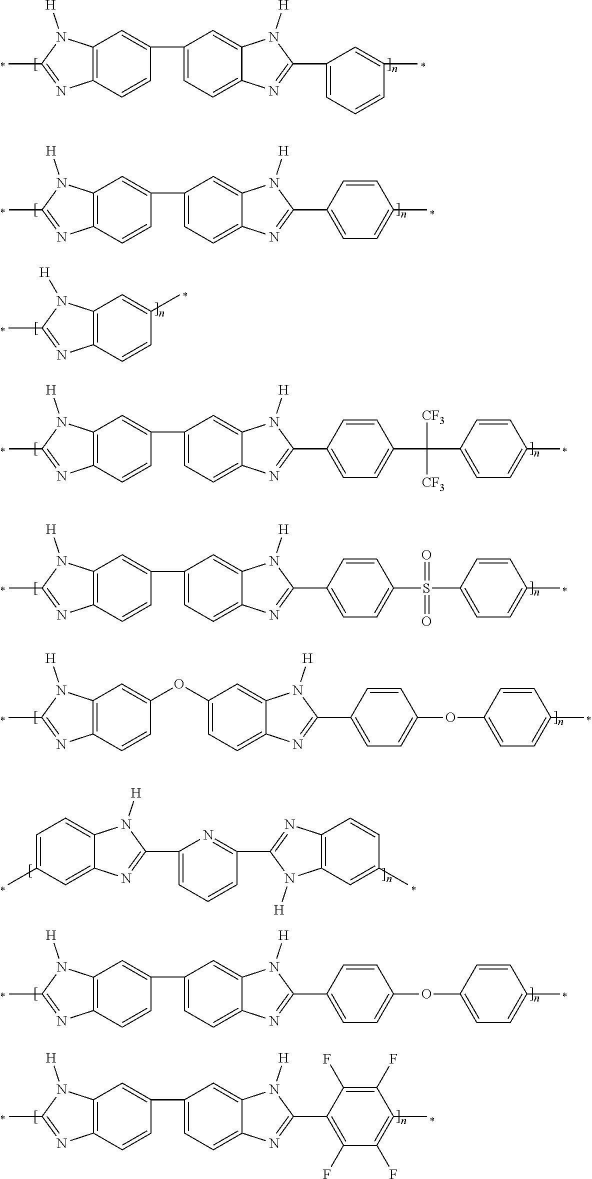
and mixtures thereof, wherein the water-insoluble polymer membrane (AEM) is in the form of a blend of the quaternized polymers and/or copolymers and the chemically inert matrix polymers,
and wherein the blend optionally contains further components selected from the group consisting of crosslinking agents, organic and/or inorganic nano- or microparticulate flow agents, fillers, carrier materials, stabilizers, phase mediators such as block copolymers, catalysts and/or dyes, and mixtures thereof.

2. The water-insoluble polymer membrane (AEM) according to claim 1, wherein the polymer or copolymer further comprises the same or different comonomers selected from the group of styrene-based comonomers and/or from the group of vinyl monomers, wherein styrene-based comonomers are selected from the group consisting of: 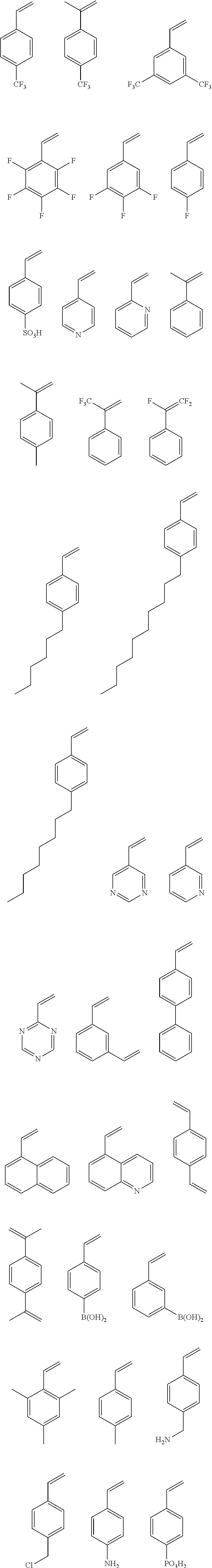 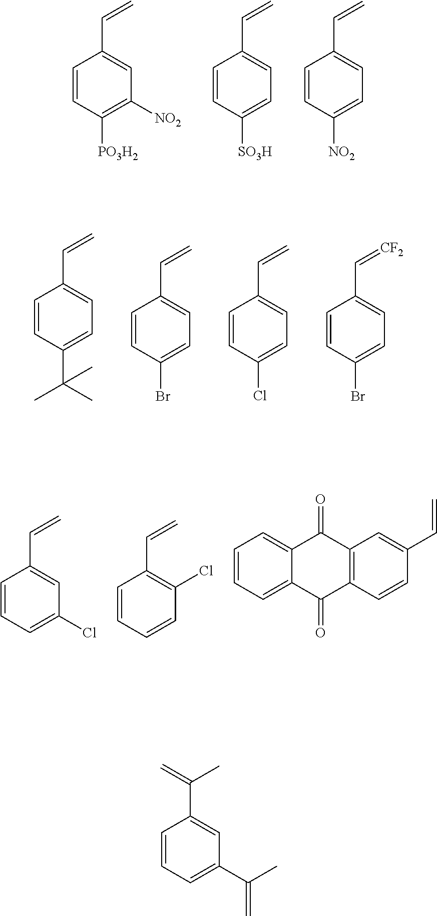
and mixtures thereof and/or
wherein vinyl monomers are selected from the group consisting of: 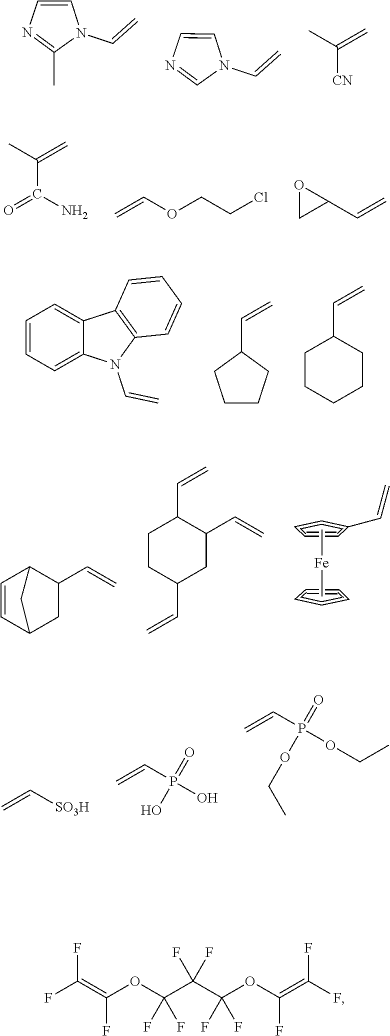
mixtures thereof.

3. A polymer or copolymer containing quaternized alkane styrene monomer units of the following formula (I), 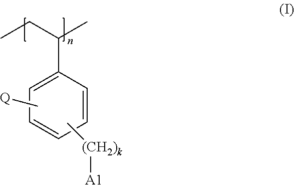
k=3 to 20;
Q=0-3 same or different substituents selected from the group consisting of alkyl, alkenyl, heterocyclyl, aryl, heteroaryl, alkoxy, aryloxy, heteroaryloxy, nitro, nitroso, halogen, and combinations thereof;
A1=an amine base selected from the group consisting of 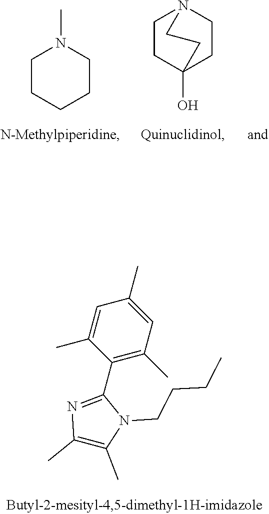
wherein the bond to the —(CH₂)ₖ spacer of the alkane styrene monomer unit (I) takes place via a nitrogen atom to form a quaternary ammonium group;
and wherein n denotes the degree of polymerization.

4. Use of the water-insoluble polymer membrane (AEM) as recited in claim 1, as alkaline (anion exchange) membrane/as anion-conducting membrane, as a binder material for the production of electrodes or catalyst layers or as an electrolyte or as an ionomer or as a binder material for the production of electrodes or catalyst layers or in electrolysis processes, electrodialysis, (electro)diffusion dialysis, Donnan dialysis or in fuel cells or in water electrolysis processes, in fuel cells or in (redox) flow batteries.

5. Process for the preparation of the polymers or co-polymers according to claim 3 by
(A) polymerization of monomers according to the formula (II-A) 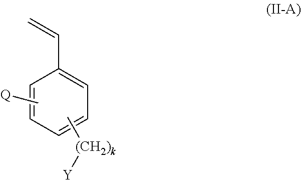
with
k=3 to 20;
Q=0-3 same or different substituents selected from the group consisting of alkyl, alkenyl, heterocyclyl, aryl, heteroaryl, alkoxy, aryloxy, heteroaryloxy, nitro, nitroso, halogen, and combinations thereof;
Y=a leaving group; and
wherein monomers of the formula (II) with the meaning of k=6 and Y═Br are excluded, and subsequent introduction of amine bases to introduce quaternary ammonium groups with quaternization of the alkyl chains and release of the leaving groups Y; or
(B) polymerization of quaternized monomers according to the formula (II-B) 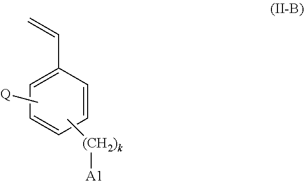
with
k=3 to 20;
Q=0-3 same or different substituents selected from the group consisting of alkyl, alkenyl, heterocyclyl, aryl, heteroaryl, alkoxy, aryloxy, heteroaryloxy, nitro, nitroso, halogen, and combinations thereof; and
A1=an amine base selected from the group consisting of 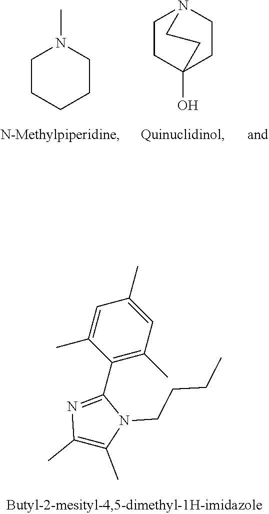
wherein the bond to the —(CH₂)ₖ spacer of the monomer unit (II) takes place via a nitrogen atom to form a quaternary ammonium group;
and wherein n denotes the degree of polymerization;
and/or
(C) (co)-polymerization of monomers according to the formula (II-A) and quaternized monomers according to the formula (II-B) and subsequent introduction of amine bases to introduce quaternary ammonium groups with quaternization of the alkyl chains and release of the leaving groups Y.

6. Process for the preparation of the water-insoluble polymer membrane according to claim 1, by blending the polymers and/or copolymers according to formula (I) with at least one chemically inert matrix polymer, or mixtures thereof.

7. The water-insoluble polymer membrane (AEM) as recited in claim 1, wherein k is ≥4 to 20.

8. The water-insoluble polymer membrane (AEM) as recited in claim 1, wherein k is ≥6 to 20.

9. The polymer or copolymer containing quaternized alkane styrene monomer units as recited in claim 3, wherein k is ≥4 to 20.

10. The polymer or copolymer containing quaternized alkane styrene monomer units as recited in claim 3, wherein k is ≥6 to 20.

11. Use of the water-insoluble polymer membrane (AEM) as recited in claim 2, as alkaline (anion exchange) membrane/as anion-conducting membrane, as a binder material for the production of electrodes or catalyst layers or as an electrolyte or as an ionomer or as a binder material for the production of electrodes or catalyst layers or in electrolysis processes, electrodialysis, (electro)diffusion dialysis, Donnan dialysis or in fuel cells or in water electrolysis processes, in fuel cells or in (redox) flow batteries.

12. Use of the polymer or copolymer containing quaternized alkane styrene monomer units as recited in claim 3, as alkaline (anion exchange) membrane/as anion-conducting membrane, as a binder material for the production of electrodes or catalyst layers or as an electrolyte or as an ionomer or as a binder material for the production of electrodes or catalyst layers or in electrolysis processes, electrodialysis, (electro)diffusion dialysis, Donnan dialysis or in fuel cells or in water electrolysis processes, in fuel cells or in (redox) flow batteries.

13. The process for the preparation of the polymers or copolymers according to claim 5 wherein k is ≥4 to 20 in at least one of formula (II-A) or formula (II-B) or wherein k is ≥4 to 20 in both formula (II-A) and formula (II-B).

14. The process for the preparation of the polymers or copolymers according to claim 5 wherein k is ≥6 to 20 in at least one of formula (II-A) or formula (II-B) or wherein k is ≥6 to 20 in both formula (II-A) and formula (II-B).

15. The process for the preparation of the water-insoluble polymer membrane according to claim 6 wherein the polymer or copolymer further comprises the same or different comonomers selected from the group of styrene-based comonomers and/or from the group of vinyl monomers, wherein styrene-based comonomers are selected from the group consisting of: 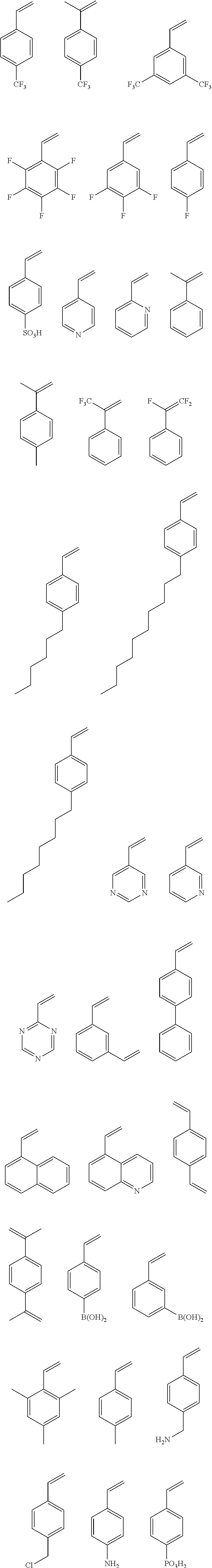 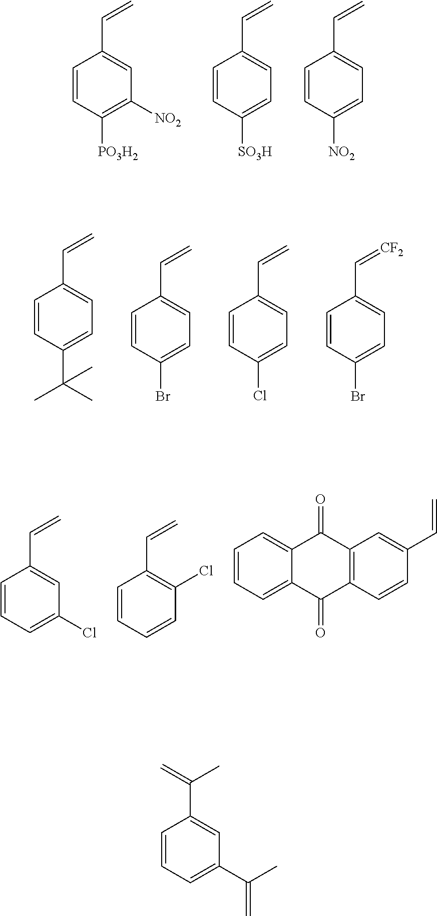
and mixtures thereof and/or
wherein vinyl monomers are selected from the group consisting of 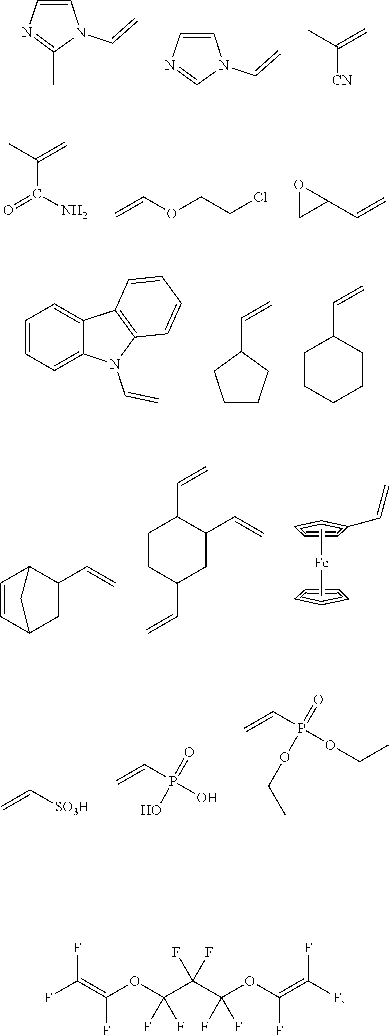
and mixtures thereof.
